(19) United States
(12) Patent Application Publication
(10) Pub. No.: US 2025/0008435 A1
(43) Pub. Date: Jan. 2, 2025

(54) SYSTEM INFORMATION ACQUISITION AND UPDATE USING ULP RECEIVERS

(71) Applicant: InterDigital Patent Holdings, Inc., Wilmington, DE (US)

(72) Inventors: Virgile Garcia, Antibes (FR); Hussain Elkotby, Conshohocken, PA (US); Keiichi Kubota, Tokyo (JP); Ali Esswie, Montreal (CA); Ravikumar Pragada, Warrington, PA (US)

(73) Assignee: InterDigital Patent Holdings, Inc., Wilmington, DE (US)

(21) Appl. No.: 18/710,482

(22) PCT Filed: Nov. 15, 2022
(86) PCT No.: PCT/US2022/049917

§ 371 Date: May 15, 2024

Related U.S. Application Data
(60) Provisional application No. 63/279,536, filed on Nov. 15, 2021.

(51) Int. Cl. H04W 52/02

(52) U.S. Cl. CPC H04W 52/0229

(57) ABSTRACT

A WTRU may receive an indication of a set of baseline configurations (e.g., the set of baseline configurations or a pointer/index to the set of baseline configurations). The set of baseline configurations may include at least a first baseline configuration and a second baseline configuration. The WTRU may receive first information (e.g., a first signature), wherein the first information indicates that the first baseline configuration is a selected baseline configuration (e.g., a current SI baseline). The first information may be received via the low power receiver. The WTRU may receive and/or determine scheduling information. The scheduling information may include at least an indication of a first schedule associated with first update information. The WTRU may receive, in accordance with the first schedule, second information (e.g., a second signature). The second information may indicate the first update information (e.g., the first update information indicating an update to the selected baseline configuration).

### CROSS-REFERENCE TO RELATED APPLICATIONS

This application claims the benefit of U.S. Provisional Application No. 63/279,536, filed Nov. 15, 2021, the contents of which is incorporated by reference herein.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth-generation (4G) long-term evolution (LTE). Wireless communication devices may establish communications with other devices and data networks, e.g., via an access network, such as a radio access network (RAN).

### SUMMARY

Systems, methods, and instrumentalities are disclosed herein for a WTRU to receive system information and system information update(s). The WTRU may comprise a processor, a main receiver, and a low power receiver, where an ultra-low power (ULP) receiver may be used as an example of a low power receiver herein. The processor may receive information via the main receiver and/or the low power receiver, e.g., as described herein. The WTRU may receive signatures via a low power receiver, where the received signatures provide information that allow the WTRU to determine a selected baseline configuration and/or update a selected baseline configuration.

A WTRU may receive an indication of a set of baseline configurations (e.g., the set of baseline configurations or a pointer/index to the set of baseline configurations). The set of baseline configurations may be baseline configurations of system information. The set of baseline configurations may include at least a first baseline configuration and a second baseline configuration. The WTRU may receive first information (e.g., a first signature), wherein the first information indicates that the first baseline configuration is a selected baseline configuration (e.g., a current SI baseline). The first information may be received via the low power receiver. The WTRU may receive and/or determine scheduling information. The scheduling information may include at least an indication of a first schedule associated with first update information. The WTRU may receive, in accordance with the first schedule, second information (e.g., a second signature). The second information may indicate the first update information (e.g., the first update information indicating an update to the selected baseline configuration). The first update information may be indicated by one or more of a time or a frequency associated with reception of the second information.

The WTRU may determine, based on the selected baseline configuration and the first update information (e.g., the first signature), a first updated version of the selected baseline configuration. The WTRU may use resources from the first updated version of the selected baseline configuration, for example until the first updated version of the selected baseline configuration is updated. The scheduling information may further comprise an indication of a second schedule associated with second update information or the WTRU may receive the indication of the second schedule separately. The WTRU may receive, in accordance with the second schedule, third information (e.g., a third signature). The third information (e.g., the third signature) may indicate the second update information. The WTRU may determine, based on the first updated version of the selected baseline configuration and the second update information, a second updated version of the selected baseline configuration. The WTRU may use resources from the second updated version of the selected baseline configuration, for example until the second updated version of the selected baseline configuration is updated. The update features described may allow for changing system information (e.g., may allow for changing system information without a need for an on-demand system information request).

In some examples, one or more of the following may apply. The selected baseline configuration may comprise a first set of resources and a second set of resources. The first set of resources may be a first plurality of information elements associated with a first system information block. The second set of resources may be a second plurality of information elements associated with a second system information block. The first update information may indicate an update to the first set of resources. For example, the first update information may indicate the update to the first set of resources by indicating that a resource in the first set of resources is to be replaced with a resource from a first corresponding set of resources in the second baseline configuration. The WTRU may determine, based on the selected baseline configuration and the first update information, a first updated version of the selected baseline configuration. The set of baseline configurations may comprise a third baseline configuration. The scheduling information may comprise the indication of the second schedule associated with second update information. The WTRU may receive, in accordance with the second schedule, the third information. The third information may indicate the second update information. The second update information may indicate an update to the second set of resources. The second update information may indicate the update to the second set of resources by indicating that a subset of resources in the second set of resources is to be replaced with a subset of resources from a second corresponding set of resources in the third baseline configuration. The WTRU may determine, based on the first updated version of the selected baseline configuration and the second update information, a second updated version of the selected baseline configuration. The WTRU may use a resource from an updated version of the selected baseline configuration to perform a measurement.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIGS. 2A-B illustrate example diagrams of energy detection (ED) based mixer-first receivers.

FIG. 3 illustrates a diagram for an ultra-low power (ULP) receiver with an all-passive RF front-end.

FIGS. 4A-D illustrate ULP networks deployed with four exemplary ULP cell types.

FIG. 5 illustrates an exemplary split between ULP RRC states and Uu RRC states.

FIG. 6 illustrates a time/frequency resource and SIB mapping.

FIG. 7 illustrates an example of successive signaling for SI update using a ULP receiver.

FIG. 8 Illustrates an example of incremental signaling for SI update using a ULP receiver.

FIG. 9 illustrates an example system information acquisition procedure performed by a WTRU in IDLE/INACTIVE state using a ULP receiver via signatures.

FIG. 10 illustrates an example procedure of SI acquisition with Uu-assisted configuration and successive SI signaling over ULP.

FIGS. 11-12 illustrate an example of on-demand ULP SI acquisition assisted by Uu transmission.

FIG. 13 illustrates an example procedure of successive and on-demand SI acquisition with Uu assistance.

FIG. 14 illustrates an example ULP system information update procedure.

FIG. 15 illustrates an example procedure of change of ULP SI signature. One or more the following may be performed.

FIG. 16 illustrates an example SIB-ULP update procedure over ULP.

FIG. 17 illustrates an example network procedure to update SI including incremental update of a SI configuration baseline.

FIG. 18 illustrates an example signaling sequence for incremental SI update using delta SIB(s) using a ULP receiver.

FIG. 19 illustrates an example of a ULP receiver-capable WTRU performing ULP-based SI incremental updates.

FIG. 20 illustrates an example of a ULP receiver-capable WTRU performing incremental and on-demand ULP-based SI update(s) with the help of Uu transmission request(s).

FIG. 21 illustrates an example of a ULP receiver-capable WTRU performing incremental updates and on-demand ULP-based SI update(s) with the help of Uu transmission requests.

FIG. 22 illustrates a ULP receiver-capable WTRU performing successive and on-demand ULP SI update.

FIG. 23 illustrates an example of a ULP receiver-capable WTRU performing dual mode (ULP and main radio) reception of SI update.

FIG. 24 illustrates a ULP receiver-capable WTRU performing incremental/successive SI update using a limited set of signatures in the case of receiving an unsupported signature.

### DETAILED DESCRIPTION

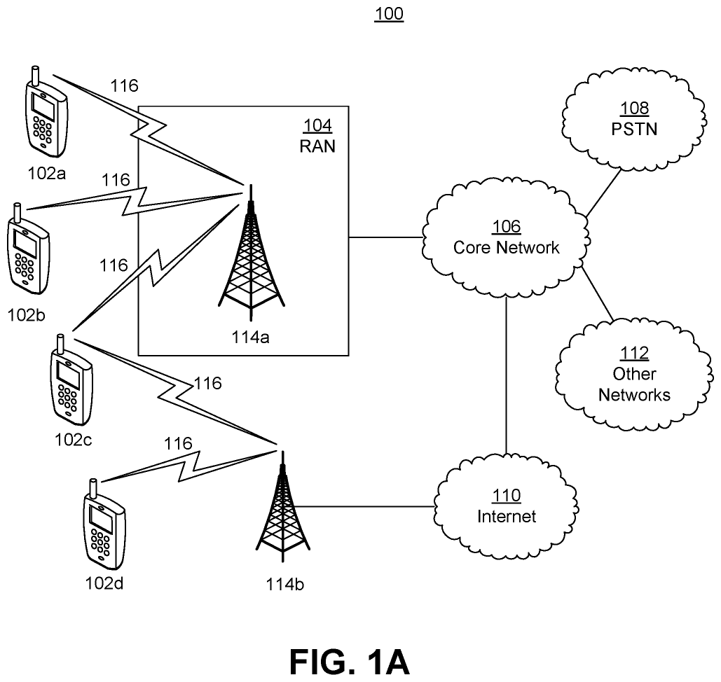

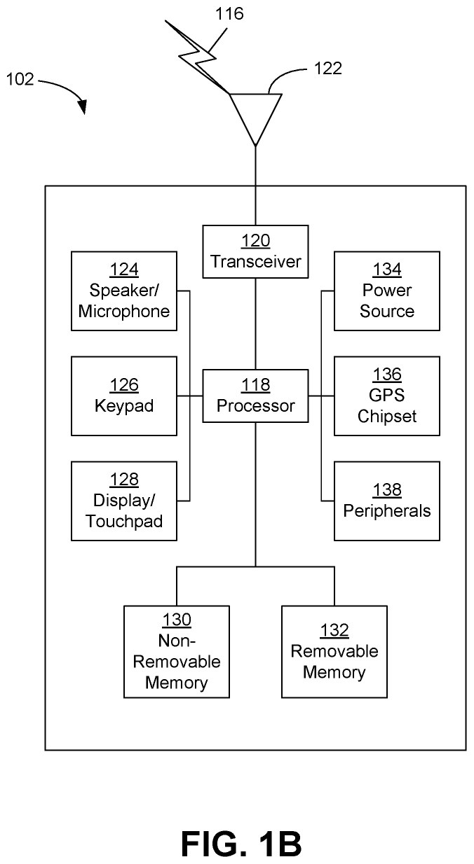

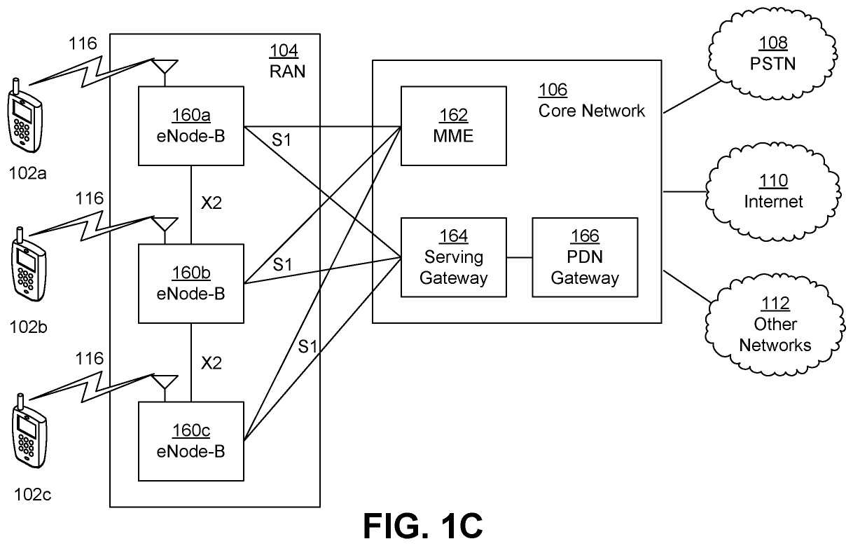

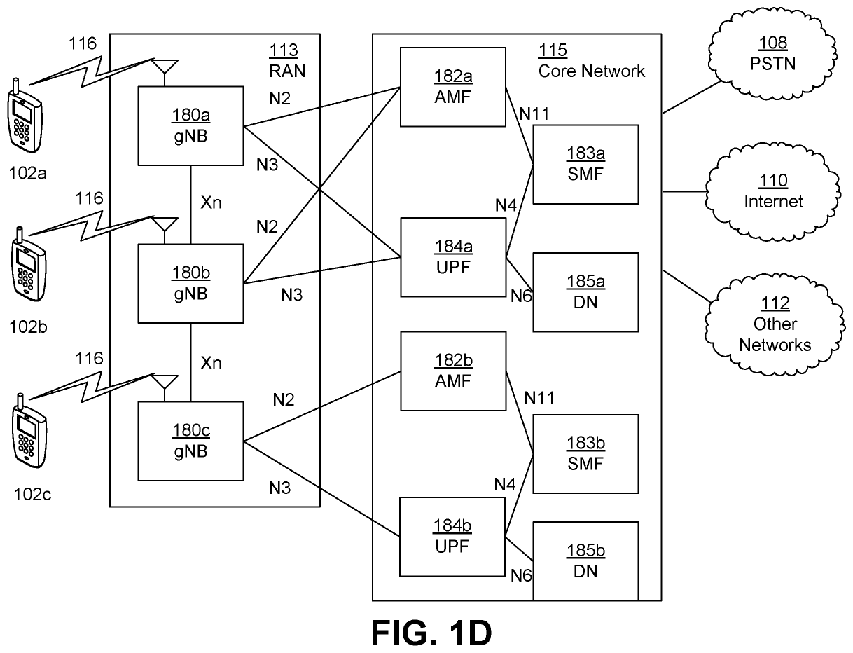

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an encode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR, etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements is depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are disclosed herein for a WTRU to receive system information and system information update(s). The WTRU may comprise a processor, a main receiver, and a low power receiver, where an ultra-low power (ULP) receiver may be used as an example of a low power receiver herein. The processor may receive information via the main receiver and/or the low power receiver, e.g., a described herein. The WTRU may receive signatures via a low power receiver, where the received signatures provide information that allow the WTRU to update a selected baseline configuration.

A WTRU may receive an indication of a set of baseline configurations (e.g., the set of baseline configurations or a pointer/index to the set of baseline configurations). The set of baseline configurations may be baseline configurations of system information. The set of baseline configurations may include at least a first baseline configuration and a second baseline configuration. The WTRU may receive first information (e.g., a first signature), wherein the first information indicates that the first baseline configuration is a selected baseline configuration (e.g., a current SI baseline). The first information may be received via the low power receiver. The WTRU may receive and/or determine scheduling information. The scheduling information may include at least an indication of a first schedule associated with first update information. The WTRU may receive, in accordance with the first schedule, second information (e.g., a second signature). The second information may indicate the first update information (e.g., the first update information indicating an update to the selected baseline configuration). The first update information may be indicated by one or more of a time or a frequency associated with reception of the second information.

The WTRU may determine, based on the selected baseline configuration and the first update information (e.g., the first signature), a first updated version of the selected baseline configuration. The WTRU may use resources from the first updated version of the selected baseline configuration, for example until the first updated version of the selected baseline configuration is updated. The scheduling information may further comprise an indication of a second schedule associated with second update information or the WTRU may receive the indication of the second schedule separately. The WTRU may receive, in accordance with the second schedule, third information (e.g., a third signature). The third information (e.g., the third signature) may indicate the second update information. The WTRU may determine, based on the first updated version of the selected baseline configuration and the second update information, a second updated version of the selected baseline configuration. The WTRU may use resources from the second updated version of the selected baseline configuration, for example until the second updated version of the selected baseline configuration is updated. The update features described may allow for changing system information (e.g., may allow for changing system information without a need for an on-demand system information request).

In some examples, one or more of the following may apply. The selected baseline configuration may comprise a first set of resources and a second set of resources. The first set of resources may be a first plurality of information elements associated with a first system information block. The second set of resources may be a second plurality of information elements associated with a second system information block. The first update information may indicate an update to the first set of resources. For example, the first update information may indicate the update to the first set of resources by indicating that a resource in the first set of resources is to be replaced with a resource from a first corresponding set of resources in the second baseline configuration. The WTRU may determine, based on the selected baseline configuration and the first update information, a first updated version of the selected baseline configuration. The set of baseline configurations may comprise a third baseline configuration. The scheduling information may comprise the indication of the second schedule associated with second update information. The WTRU may receive, in accordance with the second schedule, the third information. The third information may indicate the second update information. The second update information may indicate an update to the second set of resources. The second update information may indicate the update to the second set of resources by indicating that a subset of resources in the second set of resources is to be replaced with a subset of resources from a second corresponding set of resources in the third baseline configuration. The WTRU may determine, based on the first updated version of the selected baseline configuration and the second update information, a second updated version of the selected baseline configuration. The WTRU may use a resource from an updated version of the selected baseline configuration to perform a measurement.

Systems, methods, and instrumentalities are disclosed herein for system information acquisition and update using ultra-low power (ULP) receiver(s). A WTRU may enable energy-efficient and/or latency-efficient system information acquisition and/or updates using ULP receivers. Procedures may be implemented to support the WTRU's acquisition of system information (SI) via a ULP receiver using a signature-based index signaling during IDLE/INACTIVE state mobility. Procedures may be implemented to support the WTRU's incremental SI update over a signaled baseline SI set of configurations using index(es) and low throughput signaling to a ULP receiver. Procedures may be implemented to support the WTRU's request of on-demand SI addressed to a ULP receiver utilizing assistance from a main transceiver. Procedures may be implemented to support the WTRU's detection of unsupported SI signature(s) and consideration of fallback to legacy SI acquisition and update procedures.

The WTRU may utilize a ULP receiver to determine an updated SI configuration using a signaled index of a baseline and/or an incremental update message based on preconfigured set(s) of SI configuration, list(s) of eligible information elements (IEs) and SI block(s) for incremental update, and/or a mapping between signature-based indices and preconfigured SI configuration sets.

The WTRU may receive an SI update message via the ULP receiver indicating SI block(s) (SIBs) that are eligible for on-demand transmission to a ULP-receiver or a main receiver. The WRU may determine an interest in ULP-based SI update based on energy budget and/or mobility. The WTRU may transmit a request of on-demand SIB(s) transmission to the ULP receiver using the main transceiver.

The WTRU may determine an updated SI configuration using successive signature-based index signaling for a preconfigured list of SIBs. The WTRU may determine an unsupported signature corresponding to one of the SIBs. The WTRU may fall back to an on-demand request of the missing SIB using the main transceiver.

The WTRU may determine an updated SI configuration using successive signature-based index signaling for a preconfigured ordered list of SIBs. The WTRU may determine a list of SIBs that are eligible for on-demand transmission to a ULP-receiver using one of the determined SIBs. The WTRU may transmit a request of on-demand SIB(s) transmission to the ULP receiver using the main transceiver.

The WTRU may receive an SI update indication message via a ULP receiver indicating SIBs that are eligible for ULP signaling and/or main transceiver signaling. The WTRU may determine the receiver type (ULP or main) to be utilized for an SIB configuration update based on one or more of received update message, energy budget, or received signal strength. The WTRU may utilize the ULP receiver and main receiver to receive and/or update the corresponding SIBs' configuration.

The terms regular radio, main radio, and traditional radio may be used interchangeably. The terms regular receiver, main receiver, legacy receiver, and traditional receiver may be used interchangeably and may be used interchangeably with regular radio, main radio, and traditional radio. The terms a low power receiver and ultra-low power (ULP) receiver may be used interchangeably where a ULP receiver may be an example of a low power receiver.

In wireless technology, such as cellular and WLAN, radio frequency (RF) front-ends may be a mix of passive and active components. For example, passive components may include Rx antennas and/or Tx/Rx path switches and/or filters. The passive components may use (e.g., may require) little power or no power in order to function. The active components may require power in order to function. For example, an oscillator to tune to a carrier frequency, a low noise amplifier, and A/D converters in an Rx path may be active components.

An RF component design may enable a type of RF circuitry that is able to process received RF waveforms (e.g., which may be collected through an antenna front-end by an receiving device) with minimal usage or absence of an active power supply (e.g., a receiver that receives using low power, for example lower power than a main radio/receiver). A ULP receiver may be used herein as an example of a low power receiver. The type of RF circuitry (e.g., low power receiver) may be able to process received RF waveforms (which may be collected through an antenna front-end by an receiving device) in an Ultra-Low Power (ULP) mode, e.g., with minimal usage or absence of an active power supply. For example, such a device (e.g., receiver) may be configured to use passive RF component(s) (e.g., only passive RF component(s) and may harvest energy from a received RF waveform, e.g., to process signals, for example the WTRU may use energy harvested from a received waveform to run circuitry. In some examples, a mixer-first architecture may be used, use of an RF low noise amplifier (LNA) may be eliminated, and/or development of passive RF components may be a focus. Passive (or almost passive) ULP receivers may use RF components, such as cascading capacitors, zero-bias Schottky diodes, MEMS, or others to implement the functionality used for (e.g., required for) voltage multipliers or rectifiers, charge pumps, and/or signal detectors. ULP receivers may operate in the antenna far-field and may support reasonable link budgets.

ULP receivers may perform (e.g., may be able to perform) signal detection (e.g., basic signal detection), such as correlation for a known signature waveform and/or reception of low data rate signals. ULP receivers may be configured to operate in an energy harvesting mode, e.g., the ULP receiver accumulates energy from a RF waveform entering the ULP receiver front-end through an Rx antenna. Link budgets characteristic of base station(s) (e.g., small or medium area cellular base station(s)) may be supported. For example, ULP receivers may be used as wake-up radios (e.g., to trigger device internal wake-up and/or signal interrupts following detection of wake-up signaling) and may prompt a main receiver (e.g., a main modem) using active RF components to start up.

Reduction in device power consumption may be realized if ULP receivers are used. In examples, cellular (e.g., 3G, 4G, 5G, etc.) modem transceivers may use up to a few hundred mWs in order to demodulate and/or process received signals, e.g., during reception (e.g., active reception) such as in RRC_CONNECTED mode. Power consumption may scale with a number of RF front-end chains active on the device, a channel bandwidth used for reception, and/or a received data rate. In examples, a device may be in RRC_IDLE mode and may determine that there is no data being received or transmitted, and may enable cellular radio power saving protocols, such as (e)DRX, to ensure that the receiver may be configured to power on a few times per second. In examples, a device may perform tasks such as measuring a received signal strength of a serving and/or neighbor cell(s), e.g., for a purpose of cell (re-) selection procedures and/or reception of transmission(s) in paging channel(s). In examples, a device may perform AFC and/or channel estimation, e.g., to support coherent demodulation. Device power consumption for example devices in RRC_IDLE mode may be in the order of several mWs. In examples involving enhanced MTC (eMTC) and/or narrowband (NB)-IoT, sequence detection circuitry for processing of wake-up signals (e.g., in RRC_IDLE mode) may be implemented in the form of a wake-up receiver. In such examples, a device may power down A/D converter(s) and/or parts of a (e.g., digital baseband) processor. One or more active components in the RF front-end, such as low-noise amplifier(s) and/or oscillator(s) may be used, e.g., if power consumption associated with a LNA is (e.g., usually) in a milliwatt range. In examples, ULP receivers may be able to (e.g., may) reduce a device's power consumption (e.g., in RRC_IDLE mode) to about or below 1 mW, e.g., by removing the RF LNA and having power consumption dominated by a local oscillator.

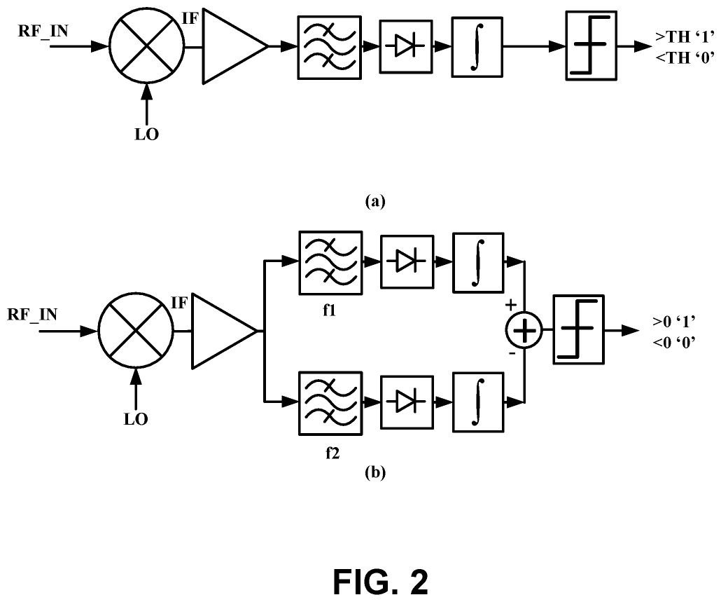

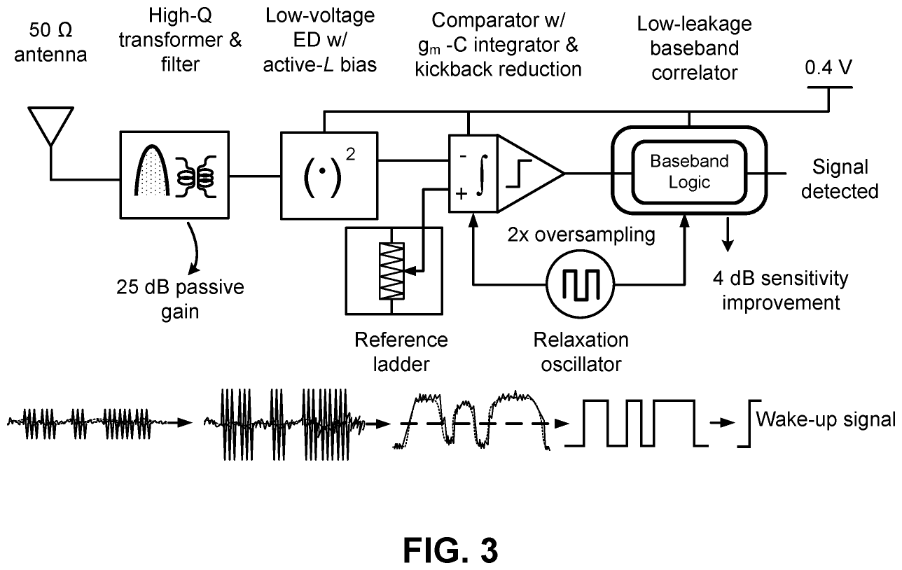

Modulation schemes, such as On-Off Keying (OOK) and Frequency-Shift Keying (FSK), may be used in ULP receivers. OOK may be attractive (e.g., due to its simplicity) in the case of designing ULP radios. FIGS. 2A-B illustrate example diagrams of energy detection (ED) based mixer-first receivers. FIG. 2A illustrates a simplified diagram of ED based mixer-first receiver for OOK radio. FIG. 2B illustrates a simplified diagram of ED based mixer-first receiver for FSK radio. FIG. 3 illustrates a simplified block diagram for a ULP receiver with an passive RF front-end (e.g., all-passive RF front-end).

WTRUs may implement one or more of RATs (e.g., 2G, 3G, 4G, 5G, etc. RATs). Such WTRUs may perform PLMN selection, cell selection/re-selection, and/or location registration procedures, e.g., in RRC_IDLE mode, WTRUs may, e.g., depending on capabilities, support manual CSG selection or MBMS frequency prioritization, e.g., in RRC_IDLE mode. WTRUs may support RNA updates and/or operation in RRC_INACTIVE state.

In response to a WTRU being switched on, a PLMN may be selected by the WTRU. RAT(s) associated with selected PLMN(s) may be set. With cell selection, a WTRU may search for a cell of the selected PLMN (e.g., a suitable cell), may choose the cell for providing the cell's available services (e.g., to the WTRU), and/or monitor the chosen cell's control channel. The WTRU may register its presence, for example by means of a registration procedure in a tracking area of the chosen cell (e.g., non-access stratum (NAS) registration).

In examples involving a WTRU in RRC_IDLE state, the WTRU may perform received signal strength measurements on serving and/or neighbor cell(s). If the WTRU finds a cell (e.g., more suitable cell) according to cell reselection criteria, the WTRU may reselect onto that cell and may camp on the cell. If the cell (e.g., new cell) does not belong to at least one tracking area to which the WTRU may be registered, location registration may be performed. The WTRU may search for PLMN(s) (e.g., higher priority PLMN(s)), where the searching may be performed at regular time intervals, and may search for a cell (e.g., suitable cell), for example if another PLMN (e.g., a higher priority PLMN) has been selected, e.g., by the WTRU's NAS (e.g., a NAS layer)).

A WTRU may lose coverage of a registered PLMN. A new PLMN may be selected automatically (e.g. by the WTRU). A new PLMN may be selected manually (e.g., an indication of available PLMNs may be presented to a user and the user may perform a manual selection). One or more means of control may exist for a network to prioritize cell selection onto RAT(s) (e.g., certain RAT(s), to control the rate at which (e.g., low, medium or high mobility) WTRUs may perform cell re-selection, and/or to prevent selected tracking area(s) from re-selection by WTRUs.

A WTRU may camp on a cell (e.g., in RRC_IDLE state or in RRC_INACTIVE state) and may receive system information from a PLMN, may establish an RRC connection or resume a suspended RRC connection, and/or may receive ETWS or CMAS notifications. If the network needs to send a control message or deliver data to a registered WTRU, the network may know the set of tracking areas in which the WTRU may be camped. A paging message may be sent to the WTRU on the control channel(s) of the cell(s) (e.g., all the cell(s)) in the corresponding set of areas. The WTRU may receive the paging message and may respond.

In some communication systems, prior to camping on a cell, a device may acquire system information of the cell and may obtain the configuration parameters associated with the cell to be camped on. System information (SI) may include parameter(s), such as a default/common Control Resource Set (CORESET), paging configuration information, and/or cell selection configuration information.

In examples (e.g., NR), SI may be divided into a Master Information Block (MIB) and/or System Information Blocks (SIBs) and/or positional SIBs (posSIBs). System Information description and acquisition are described herein.

A MIB may be transmitted on a BCH with a periodicity (e.g., of 80 ms) and/or with SSB-based repetitions made within a period (e.g., of 80 ms). The MIB may include parameters that may be used to acquire SIB1 from the cell. A first transmission of the MIB may be scheduled in subframes and repetitions may be scheduled according to a period of SSB.

A SIB1 may be transmitted on a DL-SCH with a periodicity (e.g., of 160 ms) and/or with variable transmission repetition periodicity within a period (e.g., of 160 ms). A default transmission repetition periodicity of SIB1 may be 20 ms and an actual transmission repetition periodicity may be up to network implementation. For an example involving SSB and CORESET multiplexing pattern 1, SIB1 repetition transmission period may be 20 ms. For an example involving SSB and CORESET multiplexing pattern 2/3, SIB1 transmission repetition period may be the same as the SSB period. SIB1 may include information associated with or regarding availability and scheduling (e.g., mapping of SIBs to a SI message, a periodicity, and/or a SI-window size) of other SIBs. Such availability and scheduling information may include an indication of whether one or more SIBs are provided on-demand (e.g., only provided on demand) and, if a SIB is provided on-demand (e.g., provided only on demand), may include configuration information to be used by the WTRU to perform an SI request. SIB1 may be a cell-specific SIB.

SIBs other than SIB1 and posSIBs may be carried in SI message(s), which may be transmitted, e.g., via a DL-SCH. SIBs or posSIBs (e.g., only the SIBs or posSIBs) that have a same periodicity may be mapped to a same SI message. SIBs and posSIBs may be mapped to different SI messages. An (e.g., each) SI message may be transmitted within periodically occurring time domain windows (which may be referred to as SI-windows and may have a same length for all SI messages). An (e.g., each) SI message may be associated with an SI-window and the SI-windows of different SI messages may not overlap. Within an SI-window, a corresponding SI message (e.g., only a corresponding SI message) may be transmitted. An SI message may be transmitted a number of times within an SI-window. An SIB or posSIB (e.g., except SIB1) may be configured to be cell specific or area specific, e.g., using an indication in SIB1. A cell specific SIB may be applicable (e.g., only) within a cell that provides the SIB. An area specific SIB may be applicable within an area referred to as SI area, which may include one or more cells and may be identified by a parameter (e.g., systemInformationAreaID).

A mapping of SIBs to SI messages may be configured in a first parameter (e.g., schedulingInfoList). A mapping of posSIBs to SI messages may be configured in a second parameter (e.g., posSchedulingInfoList). A SIB (e.g., each SIB) may be included in a single SI message (e.g., only in a single SI message), and each SIB and posSIB is included at most once in that SI message.

In examples involving a WTRU in RRC_CONNECTED state, a network may provide system information through dedicated signaling (e.g., using a RRCReconfiguration message), e.g., if the WTRU has an active BWP with no common search space configured to monitor for system information or paging. A network may provide system information in response to a request from the WTRU. A physical layer may impose a limit to a maximum size that a SIB may use. For example, a maximum SIB1 or SI message size may be 2976 bits.

SIB1 and other system information (OSI) may be sent via a DL-SCH within a PDSCH transmission and a DCI (e.g., a DCI scheduling the PDSCH transmission), which may be a DCI 1_0 format scrambled with a SI-RNTI. An indicator (e.g., in the DCI) may be set to identify whether the DCI includes SIB1 or OSI (e.g., via a System Information indicator bit in a Paging DCI). Search spaces for OSI may be indicated in SIB1, e.g., if they are different from SIB1 search space(s).

If the network modifies configuration(s) of the SI, the network may send a paging message (e.g., a specific paging message) to indicate the modification. The paging DCI (e.g., a DCI 1_0 format scrambled with a P-RNTI) may include Short Message(s), which may include an indication that some SI have been changed or received notification(s), e.g., via the first two bits of the Short Message field.

A WTRU may apply an SI acquisition procedure in response to one or more of the following: cell selection (e.g., in response to being powered on); cell reselection; returning from out of coverage; in response to reconfiguration with sync completion; entering a network from another RAT; receiving an indication that the system information has changed; receiving a PWS notification; receiving a request (e.g., a positioning request) from upper layers; or determining that the WTRU does not have a valid version of a stored SIB or posSIB and/or a valid version of a requested SIB.

A ULP network may comprise one or more of the following cells: a ULP cell or a Uu cell. A ULP cell may offer a ULP interface, which may enable energy efficient data communication with limited bandwidth. In relation to a Uu cell, a ULP cell may be associated with a (e.g., regular) cell serving a Uu radio interface; the (e.g., regular) cell associated with the ULP cell may be called “Uu cell”.

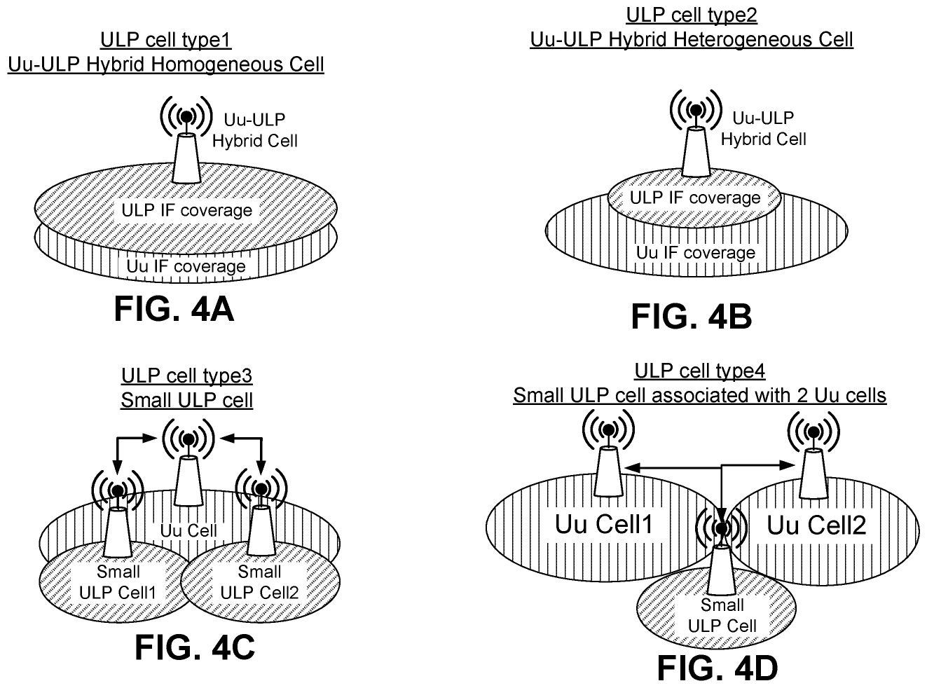

A ULP network may have exemplary types of ULP cells. FIGS. 4A-D illustrate ULP networks deployed with four exemplary ULP cell types. FIG. 4A illustrates a ULP network deployed with an exemplary ULP cell type1. The Uu-ULP Hybrid Cell may serve a Uu interface and a ULP interface, e.g., simultaneously. The Uu interface and the ULP interface may have a same geographical coverage. Reference signal(s), such as UuRS (e.g., SSB) and/or ULPRS (e.g., where ULP may be used as an example of low power herein), may be used for the Uu/ULP coverage evaluation.

FIG. 4B illustrates a ULP network deployed with an exemplary ULP cell type 2. The Uu-ULP Hybrid Cell may serve a Uu interface and a ULP interface, e.g., simultaneously. The ULP interface may have smaller geographical coverage than the Uu interface. Reference Signal(s), such as UuRS (e.g., SSB), may be used for the Uu coverage evaluation. Reference signal(s), such as ULPRS, may be used for the ULP coverage evaluation. ULP cell type 2 cell (e.g., in such manner) may provide ULPRS and UuRS (e.g., SSB).

FIG. 4C illustrates a ULP network deployed with an exemplary ULP cell type 3. A first ULP cell (e.g., small ULP cell used as an example) may serve a ULP interface for paging and/or for SI for ULP cell (ULP-SI). A second ULP cell (e.g., second small ULP cell used as an example) may serve a ULP interface for paging and/or for SI for ULP cell (ULP-SI). The first small ULP cell and the second small ULP may be associated with a Uu cell. The first small ULP cell and the second small ULP cell may be collocated within a (e.g., single) Uu cell's coverage. Reference Signal(s), such as ULPRS, may be used for ULP coverage evaluation.

FIG. 4D illustrates a ULP network deployed with an exemplary ULP cell type 4. A ULP cell (e.g., small ULP cell used as an example) may serve a ULP interface for paging and may serve SI for ULP cell (ULP-SI). The small ULP cell may be associated with two Uu cells, Uu Cell1 and UU Cell2. The small ULP cell may be located at the edges of the two Uu cells' coverages.

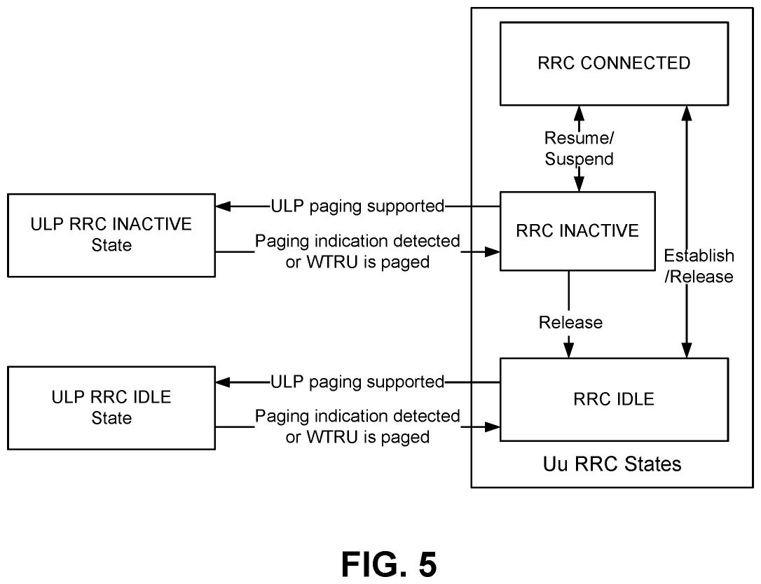

A ULP network may be deployed with one of or a combination of the ULP cell types described herein. FIG. 5 illustrates an exemplary split between ULP RRC states and Uu RRC states. ULP RRC IDLE/INACTIVE state may be an RRC state that governs a WTRU's behavior in IDLE/INACTIVE state using a first receiver (e.g., a ULP receiver). Uu RRC IDLE/INACTIVE state may be an (e.g., legacy/traditional) RRC state that governs a WTRU's behavior in IDLE/INACTIVE state using a second receiver (e.g., a traditional/legacy receiver).

WTRUs may stay in RRC IDLE state for a large amount of time and power consumption associated with IDLE mode operation(s) may have an impact on a WTRU's battery life. A WTRU may (e.g., may need to) acquire system information and/or monitor indication(s) of update(s) (e.g., any updates), e.g., to determine system parameter(s) used for the WTRU's operation(s) in IDLE/INACTIVE modes. Such operation(s) may include one or more of: monitoring of Paging Occasion(s) (PO(s)) to determine presence of network event(s); initiating a RRC Connection Establishment/Resume procedure; or transitioning to RRC Connected state. A WTRU (e.g., a WTRU implementing an Ultra-Low Power (ULP) (e.g., passive or semi-passive) receiver) may benefit from near zero power consumption if it is not performing (e.g., actively) transmission or high data rate reception. To benefit from the ULP receiver and/or extend the WTRU's battery life, feature(s) that overcome the ULP receiver's limited capacity for system information delivery may be implemented and feature(s) for ULP receiver specific system information abstraction and/or signaling may be implemented. In some examples, a Zero-Energy (ZE) receiver may consider energy harvesting to compensate for its power consumption, e.g., during IDLE mode operation(s). In some examples herein, the ULP receiver may be integrated into system(s) to support energy-efficient system information acquisition and/or update.

In some examples signaling system information using signatures may be implemented and may use machine-type communication (MTC) system information (SI) acquisition. In some examples, SI acquisition and/or update may be implemented in the case that a ULP receiver is utilized to enable deep sleep of a (e.g., traditional/main) Uu radio (e.g., for a longer time duration). Feature(s) may be implemented to enable and/or improve the system design flexibility, wherein the feature(s) may include on-demand SI signaling; support of several signaling formats, e.g., successive, incremental, implicit, or explicit signaling to enhance the design flexibility; and/or handling issue(s) related to WTRUs' (e.g., potentially varying) capabilities using indication/detection of unsupported signature(s) by ULP radio(s).

One or more features described herein may enable system information acquisition and/or system information update, e.g., using a ULP receiver. The one or more features may include indexation of system information blocks and/or information elements, e.g., for signaling to ULP receiver(s), which may have limited capacity and/or low data rate. Feature(s) described herein may include a definition of ULP specific system information related parameters, e.g., information elements. Feature(s) described herein may include enablement, signaling, and/or configuration of SI configuration sets to the WTRU's traditional radio, and/or may include indication of a SI configuration set to the WTRU's ULP radio (e.g., via signatures). Feature(s) described herein may include enablement, signaling and/or configuration of incremental update(s) of system information blocks and/or information elements, e.g., using the ULP receiver. Feature(s) described herein may include enablement, signaling and/or configuration of system information blocks and/or information elements on-demand update, e.g., using the WTRU's ULP receiver and the traditional radio (e.g., the transmitter). For example, the traditional radio may be used as an update configuration and/or as a fallback solution. Feature(s) described herein may include enablement, signaling and/or configuration of unsupported signatures, e.g., in the case of reception capability and/or missed detection.

Dual mode SI update/acquisition may refer to an implementation where the SI update/acquisition is achieved by a low-power receiver and/or a regular receiver. A determination of which receiver(s) to use may depend on configured setting(s) for a SIB (e.g., each SIB).

Low-power physical downlink control channel (e.g., where ULP physical downlink control channel may be used as an example) may be referred to as LP-PDCCH or ULP-PDCCH. LP-PDCCH may be a physical channel (e.g., a PDCCH, a PDCCH-like channel, a newly defined physical channel, etc.) that may (e.g., may be able to) carry control signals, e.g., wake-up signals and/or downlink control information (DCI) (e.g., paging DCI), with characteristics that may be specific to ULP receivers.

Low-power physical downlink shared channel (e.g., where ULP physical downlink shared channel may be used as an example) may be referred to as LP-PDSCH or ULP-PDSCH. LP-PDSCH may be a physical channel (e.g., a PDSCH, PDSCH-like channel, a newly defined physical channel, etc.) that may (e.g., may be able to) carry information signals, e.g., paging messages, with characteristics that may be specific to ULP receivers.

Serving Uu cell may refer to a Uu cell is associated with a (e.g., current) serving ULP cell. The Uu cell may provide the configuration of the serving ULP cell and/or may provide data communication link, e.g., for user data traffic and/or for RRC signaling to the WTRU camped on the serving ULP cell. More than one ULP cell may be associated with a single Uu cell.

Serving ULP cell may refer to a cell that serves ULP interface for a WTRU.

Set of SI configurations may refer to a set of SI configurations that is an ensemble of system parameters for (e.g., all) the SIBs.

List of sets of SI configurations may refer to a list of sets of SI configurations that is collection of multiple sets of SI configurations, which may be indexed.

ULP-SIB may refer to a System Information Block that may include ULP related configurations.

Uu/ULP cell may refer to an implementation that a Uu or a ULP cell may indicate separate physical or logical entities which may lead to different operational states, e.g., a legacy Uu RRC IDLE state and a ULP RRC IDLE state.

System information elements and/or System information indexing for ULP Receivers may be implemented.

ULP related system information elements and/or indexing of the ULP related system information elements may implemented.

A ULP receiver may be used to determine a set of system information parameters, e.g., for radio operation in IDLE/INACTIVE mode.

A network may transmit a SIB, for example, an additional SIB, new SIB, etc. (e.g., a ULP-SIB, which may be used as an example SIB herein), as part of the system information acquisition, e.g., by a traditional radio. The ULP-SIB may include information for the ULP receiver to use (e.g., to be able to use) to decode configured over the air channels. The SIB for ULP may be transmitted to the Uu receiver, e.g., of a traditional radio. The SIB for ULP may be scheduled/configured within a parameter (e.g., SI-SchedulingInfo) of SIB1.

SIB1 may include information regarding the availability and/or scheduling (e.g., mapping of SIBs to SI message, periodicity, and/or SI-window size) of other SIBs. The information may include an indication of whether one or more SIBs are provided on-demand (e.g., only provided on-demand) and may include, if a SIB is provided on-demand (e.g., only provided on-demand), configuration information to be used (e.g., that is needed) by the WTRU to perform an SI request. SIB1 may be a cell-specific SIB.

System information parameter(s) may be inherited from system information block(s)/element(s) intended for and/or obtained by a traditional radio, which may correspond to a single cell serving traditional and ULP radios or a cell (e.g., independent and associated cell) serving the traditional radio. The parameter set (e.g., that may be inherited) may include one or more of the following: a PLMN Identity; a tracking area identity; or a system rame number (e.g., partial or full).

By inheriting the parameters (e.g., the parameter set), the configuration obtained for one of the interfaces may be valid for the other interface(s) and may not be required to be specifically updated or configured more than once.

In some examples, there may be a system information parameter set (e.g., another system information parameter set) that may be specific to the ULP receiver and may be signaled (e.g., dedicatedly signaled) to a ULP capable WTRU. This parameter set may include one or more of the following.

The parameter set may include a ULP cell's PLMN-Identity information, e.g., if a PLMN is dedicated to ULP operations. A PLMN-Info (e.g., each PLMN-Info) in a PLMN-Info List may signal whether associated ULP cell(s) may be used by the subscriber(s) of the PLMN.

The parameter set may include a System Frame Number (SFN). A SFN may be included if (e.g., only if) a duty cycle is applied for ULP paging (e.g., if a duty cycle is not applied for ULP paging, then an SFN may not be included.)

The parameter set may include associated Uu cell(s)' information. If a ULP cell has more than one associated Uu cell, then the ULP cell may be configured to (e.g., may need to) signal the cell identities of the associated Uu cells. This association information may be used if the WTRU determines a serving Uu cell to access Uu interface (e.g., if WTRU receives/transmits some amount of data.)

The parameter set may include a signature set for ULP indexed system information signaling and/or update. A signature may be used to identify a system information configuration set of a serving cell (e.g., a current serving cell) from more than one system information configuration sets, which may be signaled to a traditional radio (e.g., via system information or (e.g., dedicated) RRC signaling (e.g., an RRCReconfiguration or RRCRelease message)), e.g., prior to switching to ULP radio operation. A parameter set (e.g., the signature set) may include one or more of signature periodicity, scheduling information, or search space information (e.g., time and/or frequency resources), e.g., based on a periodic and duty cycled operation or an opportunistic reception operation.

The parameter set may include configuration(s) for the LP-PDCCH and (e.g., in some examples) LP-PDSCH. These control and data channels may be used as alternative(s) to signatures/sequences, e.g., to carry ULP data payload, which may include data transmissions (e.g., explicit data transmissions). The configuration(s) may be or may include LP-PDCCH search space(s) configuration information and/or LP-PDSCH scheduling information configuration. The configuration(s) may be or may include LP-DCI configuration information, e.g., modulation, repetition, etc.

The parameter set may include an indication of a presence of one or more of the following: an LP-PSS, an LP-SSS, or a mapping to a Physical Cell Identity (PCI), which may be used by the WTRU to identify and/or measure the signal strength of a ULP cell.

The parameter set may (e.g., in some examples) include paging configuration information. The paging configuration information may include one or more of: a ULP-specific paging search space; a ULP-specific early paging indication configuration(s) (e.g., presence indication, DCI format and/or search space, and/or sequence information); or a ULP-specific WTRU grouping information.

The parameter set may include a Uu cell and ULP cell association. For example, a Uu cell may signal ULP cell PCI(s) associated with the Uu cell. A Uu cell may provide the ULP cell related configuration parameters for the associated ULP cell(s) and the WTRU may apply the ULP cell configuration parameters for a serving ULP cell (e.g., if the WTRU is camped on one of the associated ULP cells). The WTRU may use a Uu interface served by the Uu cell associated with the serving ULP cell (e.g., current serving ULP cell), for example if the Uu interface is determined to be (e.g., needs to be) used.

The parameter set may include information (e.g., configuration(s) for SI acquisition, such as enabled features for SI acquisition, e.g., incremental SI update, successive SI update, on-demand SI update, split between Uu and ULP SI, etc.

The parameter set may include a power profile for a user to use ULP or Uu interface (e.g., a remaining battery life percentage at which the WTRU is configured to trigger usage of ULP).

System information indexing may be implemented.

System information may be signaled, for example with a limited number of information bits and/or (e.g., relatively) short sequence(s), which may help a ULP receiver (e.g., which may have limited throughput) acquire and/or update system information parameter(s), e.g., regardless of the help of a Uu transceiver. This may involve the use and/or definition of system information signatures/sequences (e.g., signature or sequence may be interchangeably herein) as an indexing scheme and/or mapping to (e.g., existing and/or newly) defined system information blocks and/or elements. The signaling of system information may involve the definition of incremental system information update messages.

SI index(es) may be signaled via signature(s) (e.g., ULP signature(s), which may be used as an example herein).

To overcome capacity limitation(s) and a limited number of sequences a ULP receiver may support, the acquisition of the SI may be compressed. The network may transmit sequence(s) that may act as signature(s) to identify which configuration set the WTRU may use, e.g., if a network may determine (e.g., desire) to update or change a SI configuration. The mapping between a signature and its corresponding configuration set may be used by the WTRU and may be received (e.g., initially received) by the main radio using a traditional Uu interface (e.g., using dedicated SIB configuration and/or RRC signaling), on a condition of which the WTRU may camp to a ULP cell and/or switch to ULP receiver operation. For example, a ULP-SIB-List configuration information may be sent over a traditional Uu interface, e.g., via system information sent from a (e.g., current) serving cell or a (e.g., dedicated) RRC message. The configuration information may include a list of possible configuration sets (e.g., a set of baseline configurations) that may be used by ULP-capable cells within an area. The signature for a configuration set (e.g., each) configuration set may be related to configuration content (e.g., hashing the content) or may be based on the index of a row in the list.

The signature(s) may be network-specific or specific to a group of cells within a specific area. A signature (e.g., specific signature) may be broadcast within a cell (e.g., each cell may have a specific signature). The signature may broadcast to served ULP-capable device(s) to indicate a corresponding (e.g., desired or indicated) system information configuration set (e.g., a selected baseline configuration). Signatures and sequences may be received by a ULP-capable device such as a WTRU (e.g., using a low-power correlator or receiver). For example, a signature or sequence may be received at any time (e.g., regardless if there is predefined scheduling or timing associated with a configuration or signatures). Signatures may be received by the ULP receiver, e.g., according to a predefined scheduling sequence. Signatures may be sent following a reference signal (e.g., LP-PSS and/or LP-SSS) and the receiver may be able to identify the source of a signature (e.g., based on the received reference signal). The timing between the reference signal and the signature may be part of a scheduled/configured sequence. The timing between the RS and the signature may be part of a configuration (e.g. SIB-ULP), or may be part of a scheduling information received via a signature/sequence.

The ULP receiver may perform duty cycled monitoring for the signatures, e.g., for SI acquisitions and/or updates. If the ULP receiver is using a duty cycle, the ULP device may check the SFN of the system and may check for the periodicity of the SI monitoring. For example, if the periodicity of a duty cycle is N, the ULP device may monitor signatures if SFN mod N=x, x∈{0, 1, . . . , N−1}. A network, e.g., based on the duty cycle configuration, may (e.g., in response) transmit signals in the corresponding frames.

A broadcast signature (e.g., each broadcast signature) may be mapped to one or more of the following: a complete SI configuration set, including the active SIBs of the system (e.g., all the active SIBs of the system); a partial/subset SI configuration set, e.g., one or more SIB(s) configuration from the active SIBs of the system; or a partial SIB configuration or an information element or a set of information elements.

The network may transmit a set of configurations to a WTRU (e.g., a set of baseline configurations), for example to a WTRU with a ULP receiver. The transmission may be through a Uu SIB or RRC signaling. The network may (e.g., subsequently) transmit a sequence, which may act as a signature to the WTRU. The WTRU may determine a configuration (e.g., a selected baseline or a baseline to use to update a selected baseline configuration) based on the received signature, e.g., by retrieving the configuration to apply based on the signature received from the network. The signature may be received by the WTRU via a low power receiver.

For example, the network and ULP devices may support multiple signatures, where an example of eight supported signatures may be used. The network may configure the devices to have a corresponding set of four different complete SI configurations, two configuration sets specific to the ULP-SIB, and two configuration sets for specific IEs that are frequently changed.

The sets of SI configurations may be represented as a list of sets of SI configurations, wherein an index (e.g., each index) of the list may map to a set of SI configuration, which may be a full set of SIB parameters. This may be viewed as a large table of parameters, wherein an index/column combination (e.g., each index/column combination) may be/indicate a parameter. Other suitable variants of storage and representation of SI parameters are not precluded and may similarly be implemented,

Successive SI signaling may be performed via reusable signature(s).

Signaling through signatures and/or sequences may carry (e.g., extra) bit(s) of information, e.g., without increasing a maximum number of signatures a ULP receiver may be able to search for and/or decode. The ULP interface (e.g., in such manner) may be able to multiply the number of configurations and/or configuration updates (e.g., with its limited capacity) and may reduce the complexity of the received signature.

In examples, a first indication may inform the WRTU that SI updates may be incoming, and the several time slots and/or windows may be expected to include different parts of the SI configuration. A timing (e.g., each timing), for example where a timing may be a time slot and/or time window, may refer to a configuration subpart or a set of possible configurations to choose from. For example, a successive time window (e.g., each successive time window) may correspond to a SIB update and the associated mapping configuration.

By having distinct scheduling for different SIB and/or IE updates, in these (e.g., each of these) scheduled windows, supported and possible signatures available (e.g., all supported and possible signatures available) may be reused. A mapping between a signature and an associated configuration for a (e.g., each) scheduled update may be sent over Uu, e.g., via SIB or RRC reconfiguration.

If a successive SI signaling procedure is associated with a starting signal as a reference, one of the signatures that is received (e.g., anytime) by the WTRU may be configured to refer to the start of this procedure. In response to receiving this signature, the WTRU may start the successive update procedure and may expect the network to transmit further signals for scheduled configuration(s) (e.g., each scheduled configuration).

In examples, the WTRU, e.g., in response to receiving an identifiable signature, may determine an associated configuration change or update to perform, e.g., based on the signature and the scheduling of that signature.

In a ULP physical layer configuration, timing and/or frequency specific area(s) in the spectrum may be defined and the receiver, e.g., based on this configuration, may identify the correspondence between a received signature and what it represents, e.g., a first signature at a specific time instance and frequency resource may corresponding to a first SIB.

For example, a time separation may be configured to update different SIB and/or SI IEs. The timing of these time separations (e.g., windows) may be configured with respect to a frame index, synchronization signal(s), and/or a previous signaling that indicates following signatures.

The timing of each successive transmission window may be (pre)configured and may be shared with a ULP device. For example, the starting point of the procedure may be configured to be a given signature index, and the starting time (e.g., offset between the beginning of the window and previous signature or window) of a window (e.g., each window) and a duration of a window (e.g., each window) may be configured (e.g., jointly) with a corresponding meaning (e.g., a SIB index). The timing configuration may relate to OFDM symbols, slots, subframes used by the main radio (e.g., in NR), or absolute time and durations (e.g., ms). The frequency domain configuration may relate to resource blocks, sub-bands, bandwidth parts, etc.

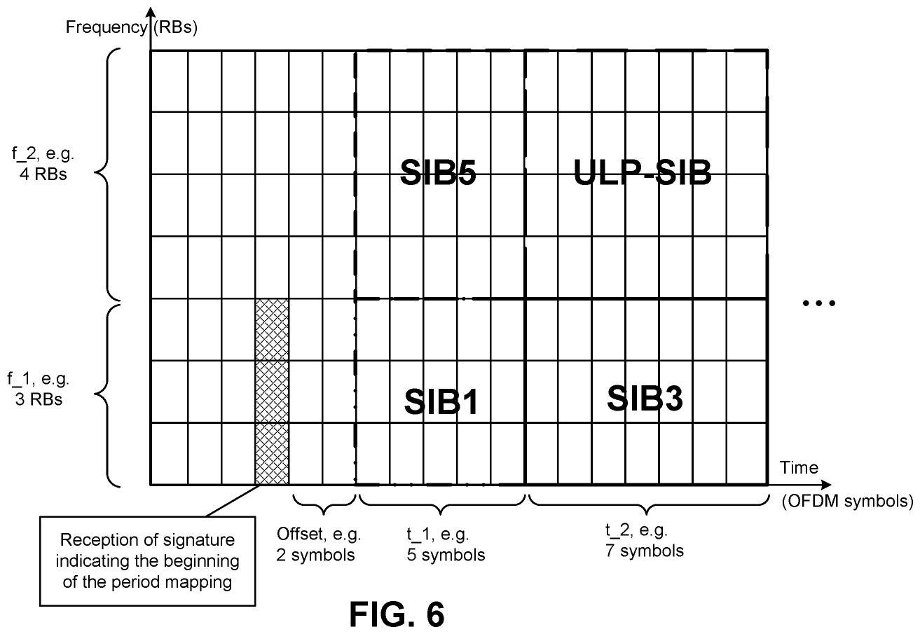

Successive signaling windows (e.g., two windows) may have a same duration (e.g., 5 symbols) or different durations (e.g., 5 and 7 symbols, respectively). The WTRU may be able to monitor for (e.g., at the same time) more than one signature that may be multiplexed in the frequency domain and may interpret the frequency and time resources used, e.g., to map the signature with the configured content. In an example, FIG. 6 illustrates a time/frequency resource and SIB mapping. In FIG. 6, four signaling resource pools over two time resources (t_1 and t_2) and two frequency resources (f_1 and f_2) are shown. As shown, (t_1, f_1) maps to SIB1, (t_2, f_1) maps to SIB3, (t_1, f_2) maps to SIB5, and (t_2, f_2) maps to ULP-SIB.

Multiple signatures received may be mapped differently.

In the case of SI signaling (e.g., a periodic SI indication), the indices (e.g., all the indices) received on a physical layer, and their respective time and frequency window, may be mapped (e.g., jointly) mapped) into a logical index. The logical index may refer to a table (e.g., larger table) with entries for possible SI configurations.

In the case of an SI update, a time/frequency window (e.g., each time/frequency window) may be configured to an update (e.g., a specific update), for example a group of SIBs, a SIB, a group of IEs, etc. An indication (e.g., index) received in that window may refer to the table of SI configurations. The SI configuration to use (e.g., the SI configuration to use at a current instance) may be the ongoing SI configuration baseline (e.g., selected baseline configuration) with updates if received, where updated IEs/SIBs may use the values from the received indices. That is, at least two indices may be used: one for the baseline (e.g., selected baseline configuration) and other(s) for specific updates overriding the baseline values. In some examples, instead of referring to the same table of configuration as the baseline, signatures in the windows may refer to indices in other (e.g., additionally configured) tables of SIBs/SIB/IEs configurations, which may (e.g., also) override the baseline values.

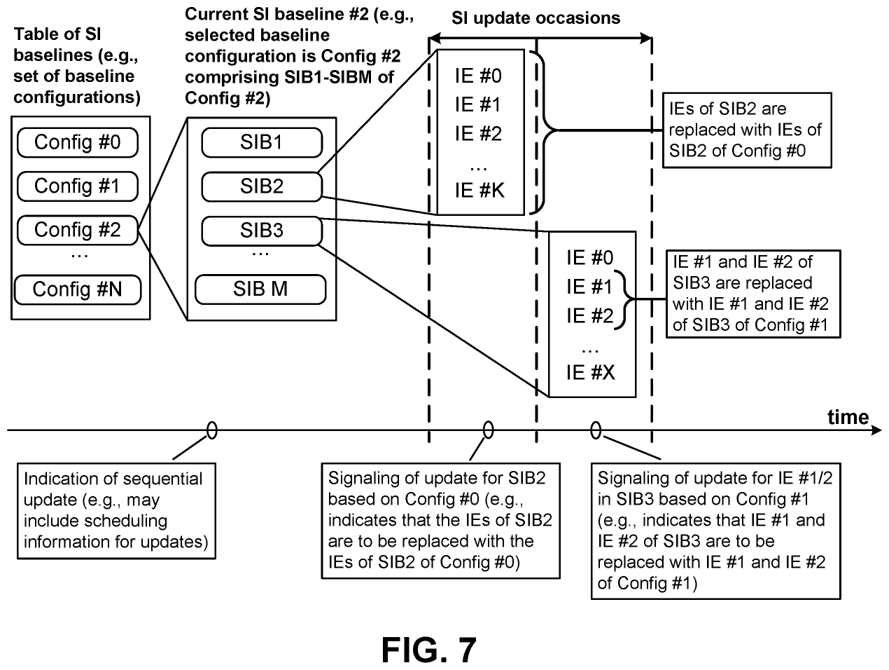

As described herein, a WTRU may receive a set of baseline configurations (e.g., an indication of a set of baseline configurations. FIG. 7 illustrates an example of successive signaling for SI update(s) to a WTRU, e.g., using a ULP receiver. FIG. 7 illustrates an example of the received set of baseline configurations at Table of SI baselines (e.g., Config #0-#N). As shown, an indication of a sequential/successive update at Indication of sequential update may be received by the WTRU (e.g., via the ULP receiver), where the WTRU is using (e.g., currently using) a SI baseline configured as index 2 (e.g., Current SI baseline #2 is Config #2). For example, the WTRU may be using Config #2 as the selected baseline configuration, where the selected baseline configuration may have been indicated to the WTRU as the selected baseline configuration (e.g., as described herein). A following first sequence/signature may be signaled to the WTRU (e.g., received by the WTRU, for example via the low power receiver) to indicate that SIB2 of Config #2 (e.g., the selected baseline configuration) is to be modified according to the values of the SI baseline configuration index 0 (e.g., Config #0). For example, as shown in FIG. 7, based on the reception of the first sequence/signature, the WTRU may replace the IEs in SIB2 of Config #2 (e.g., the selected baseline configuration) with the IEs of corresponding SIB2 from Config #0 (e.g., resulting in a first updated version of the selected baseline configuration). Subsequent to the signaling of the first sequence/signature, a second sequence/signature may be signaled to the WTRU (e.g., received by the WTRU, for example via the low power receiver) to indicate that some IEs (e.g., IE indexes 1 and 2) of SIB3 are to be modified to use the IE values found in the baseline configuration index 1 (e.g., Config #1). For example, as shown in FIG. 7, based on the reception of the second sequence/signature, the WTRU may replace IE #1 and IE #2 of SIB3 of the first updated version of the selected baseline configuration with IE #1 and IE #2 of corresponding SIB3 from Config #1 (e.g., resulting in a second updated version of the selected baseline configuration). The SI configuration to use after the second update (e.g., the second updated version of the selected baseline configuration) may be a merge of the indicated baselines for selected IEs/SIBs. The first and second sequences/signatures may be a same sequence/signature or different sequences/signatures.

Incremental/structured partial SI update message(s) may be implemented.

SI may be signaled incrementally, e.g., using partial SI updates that may be structured and/or may complete each other. Having a comprehensive list of configurations for all SIBs may not be practically feasible. The number of potential combinations for the IEs in each SIB may be large and may cost a large overhead in an initial configuration (e.g., even over a traditional interface) and the index itself may have many bits to convey. An incremental approach may be used wherein the SI update may be made using a SI configuration baseline and additional IE updates. A succession of signaling may be performed to first establish a baseline. For example, a WTRU may have received a set of baseline configurations. The network may transmit the signature of a known SI configuration (e.g., of the set of baseline configurations) to a WTRU (e.g., received via a ULP receiver), for example the known SI configuration indicated by the signature may be a selected baseline configuration. The network may (e.g., subsequently) transmit one or several signals to indicate which IEs in the selected baseline configuration (e.g., if any) to modify. The incremental update signals may indicate which IE(s) is/are updated and/or an indication of the update value(s) (e.g., the values or a pointer to the values). The indication of the value(s) in an incremental update may be absolute values (e.g., the value of the configuration) or a relative value as compared to the baseline (e.g., the configuration value intended to be used (e.g., desired) is the sum of the incremental update value and the baseline configuration value).

If an incremental SI signaling/update procedure is configured to be supported, one of the signatures that may be received (e.g., anytime) by the WTRU may be configured to indicate the start of this procedure. In response to receiving this signature, the WTRU may start the incremental signaling/update procedure and may expect a network to transmit further signals for the incremental update of SI configuration.

In order to be able to perform the incremental update, the network may send configuration information (e.g., to the WTRU) that may indicate the support of ULP-based incremental updates. The configuration information may include indication(s) of which SIB(s) are covered by this feature and which are not. For example, the configuration may include a list of SIBs in an IE (e.g., dedicated IE) of ULP-SIB, indicating which SIB(s) may support the incremental update. The list may be represented as a list of Boolean values of the (e.g., existing or configured) SIBs to be received by the WTRU(s).

Within a SIB supporting the incremental update, configuration information indicating which IE(s) may support the incremental update may (e.g., also) be sent to the WTRU(s). For example, the configuration may include a list of IEs for the (e.g., concerned) SIBs in an IE of ULP-SIB, e.g., indicating which IE(s) support the incremental update. The list may be represented as a list of Boolean values of the (e.g., existing or configured) IEs to be received by the WTRUs, e.g., in a SIB (e.g., each SIB).

For an IE that can use the incremental update (e.g., for each IE that may be able to use the incremental update), information may be received on how the how the updates are performed (e.g., the WTRU may receive configuration information indicating how the IE is incrementally updated), e.g., one or more of the following examples may apply.

For example, a value obtained with a hierarchical update signal may replace a value of the baseline configuration. In this case, the value obtained via the hierarchical update signal may be configured to be any value possible, and (e.g., thus) the number of bits of this IE may be the same as the one in the original SIB. In some examples, the value may be configured to be a subset of the possible values, e.g., to reduce the number of bits used (e.g., required) for this IE.

For example, a value obtained with the incremental update signal may be used that is added to a value of the baseline configuration. The number of bits of this incremental update may be configured to be smaller than the number of bits of the (e.g., actual) IE. In the case of consecutive integer values, if the update is coded over 3 bits, the update may produce a gain of 0 to 7 for the second value of the baseline. The update may be configured to have positive and negative values, e.g., −3 to +4. If the IE value is taken from a non-contiguous set of values, the update value may refer to an increment of an index in that set.

For example, a partial update of a value may be sent over the SI update signal, e.g., wherein a subset (e.g., only a subset) of the bits of the IE may be configured to be sent. The subset of the bits of the IE may replace the bits of the IEs of the baseline configuration. The partial bit update may be set to replace the three Least Significant Bits (LSB) of the original value. The baseline configuration may (e.g., in such manner) be set to have a configuration (e.g., broad configuration) and the partial update may provide a refinement to the configuration. The subset of bits of the IE that may be configured to be replaced in the partial update may be flexible (e.g., fully flexible) and may be sent in the configuration, e.g., as a binary mask of bits for the (e.g., concerned) IEs.

In the case of configuring the baselines and updates, the network may select the baselines and may update configurations to minimize overhead. For example, the network may (e.g., with cooperation between cells) know and/or obtain the potential configuration(s) that a WTRU may receive in neighboring cell(s) (e.g., a number (e.g., a few) neighboring cell(s)). The network may (e.g., in response) configure several baselines to be received (e.g., through signatures) and the corresponding updates that may minimize overhead (e.g., total overhead). The network may (e.g., also) select the baselines and may update configurations, e.g., based on a history of the network's own SI configuration.

The incremental updates (e.g., which may be referred to as delta SIBs) may include the same IEs as the SIBs originally defined and the IEs in the delta Uu SIBs may be defined as optional IEs. The network may omit one or more of the IEs and the omitted IE(s) may be not updated as part of the (e.g, current) SI update procedure. If not all the IEs are eligible for incremental updates, the eligible ones (e.g., only the eligible ones) may be listed.

Shown below are two example tables describing a possible SIB (e.g., RRC defined SIB) and a corresponding delta SIB/delta Uu SIB.

TABLE 1
Example: RRC defined SIB

| | |
|---|---|
| SIBX ::= | SEQUENCE { |

```
  IE1,
  IE2,
  IE3,
  IE4
}
```

TABLE 2
Example: Delta SIB

| | |
|---|---|
| Delta-SIBX ::= | SEQUENCE { |
| IE1 | OPTIONAL, |
| IE2 | OPTIONAL, |
| IE3 | OPTIONAL, |
| IE4 | OPTIONAL |

}

The example shows that the IEs in delta SIB/delta UuSIB are defined as optional IEs, e.g., one (e.g., only one) of the IEs (IE1, IE2, IE3 or IE4) in Delta-SIBX may be present in the delta SIB/delta Uu SIB. The SIBX may (e.g., may need to) include the mandatory IEs (e.g., all IEs (IE1-4) may be present).

A rough estimation of overhead reduction that the incremental update feature may bring may be seen as a difference between the fields that are not needed to be updated and the IE field indicator that is in log 2 of the total number of optional IE fields. 10 bits for the indicator may be able to cover 1024 IEs, and (e.g., thus) the delta SIB may have very few IEs not to update in order for the overhead cost to be reduced. In the case of a 5 to 8 bits per IE field, if 2 IEs are not updated, there may be a net gain in overhead. For example, in the case of a SIB whose total load is 512 bits (e.g., the maximum allowed SIB size being 2976 bits), if a desired configuration is not in the configured signatures, the network would have to signal the 512 bits. In the case of using the incremental approach, the network may (e.g., first) signal the baseline configuration (e.g., say 5 bits for 32 possible signatures) and the incremental updates, e.g., wherein the increment updates may depend on the number of IEs to update. The incremental SIB may carry log 2 of the number of optional IEs of the SIBs (e.g., 8 bits), which may be used to indicate the updated fields and the values of updated IEs (e.g., 8 bits for each). If 5 IEs are determined to get (e.g., requiring) an update, 5 (signature)+80 (5*delta SIB) bits (e.g., instead of 512) may be sent.

The incremental updates may be signaled, e.g., using signatures or using (e.g., explicit) data. In the case of signatures, their corresponding contents may be listed, indexed, and/or configured with the IE configuration. Such method of using signatures may limit the number of potential updates and/or the flexibility.

In the case of using explicit data, the data may be (e.g., may need to be) decoded by the WRTU and may be sent over a ULP data channel, e.g., an LP-SCH. In preparation for signaling the incremental updates using that data (e.g., prior to that data), an indication of incoming data may be sent from the network with a signature signal, which may enable the WRTU to monitor for (e.g., expect) the following data to arrive. The WRTU may (e.g., also) resynchronize with the ULP cell to be able to correctly decode the incoming data packet.

The explicit data content may be (e.g., more easily be) updatable and may include any SI configuration and/or (e.g., specific) IE elements and values. The data may (e.g, also) include an index or reference to pre-set list(s) of configurations, e.g., similar to the signature ones.

To avoid (e.g., large) overhead on the capacity-limited ULP interface, the explicit data transfer may be limited to elements (e.g., specific elements) or group of elements. The explicit data may (e.g., also) be limited to a difference between the desired SI configuration and a SI configuration present in the list of configurations at the WTRU side.

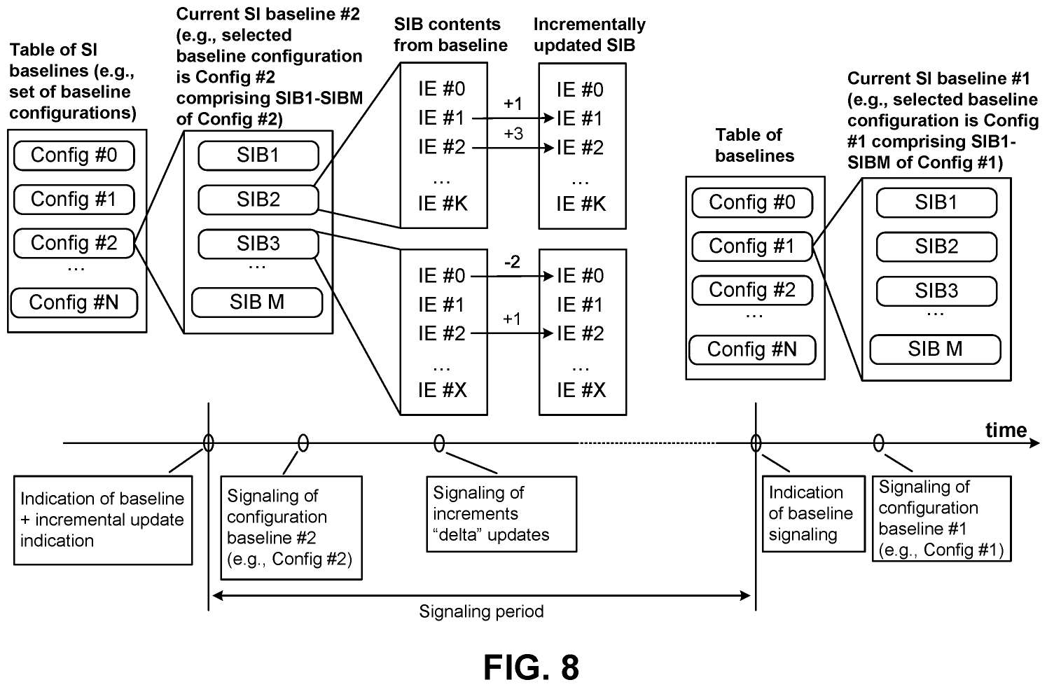

FIG. 8 Illustrates an example of incremental signaling for SI update, e.g., signaling to a WTRU using a ULP receiver. As shown, an incremental SI update (e.g., indication of use of the procedure at Indication of baseline+incremental update indication) may be indicated by a signature (e.g., a dedicated signature), which may be followed by a first signature indicative of a baseline SI configuration set, e.g., a selected baseline configuration, which in the example of FIG. 8 may be configuration set #2 (e.g., Config #2). The first signature may be received at a time offset, e.g., from the SI update indication or within a first time slot at a time offset from the received SI update indication. The WTRU may receive (e.g., subsequent to receiving the first signature) an incremental update message, for example, a delta-SIB, indicating an update of two IEs in SIB2 and two IEs in SIB3 of the SI configuration set #2 (e.g., the selected baseline configuration). The delta-SIB may include (e.g., also include) the incremental updates of the indicated IEs, e.g., IE #1 in SIB2 is increased by a value of 1. The WTRU may update the indicated selected baseline configuration, e.g., Config #2, using the received incremental updates in the delta-SIB and may apply the updated SI configuration. For example, the result may be an updated version of the selected baseline configuration. In examples herein, a resource from the updated version of the selected baseline configuration may be used by the WTRU (e.g., to perform a measurement, etc.).

Specific SI updates message indication may be implemented.

A sequence (e.g., specific sequence) of signatures may be used to implement (e.g., indicate) the ongoing SI update/acquisition. A sequence may indicate which SI block and/or element(s) are to be updated and following sequence(s) may refer to the (e.g., actual) configuration to be applied to the SI block and/or elements (e.g., referring to an index of a corresponding configuration list). A list of configurations may be prepared for an SI block (e.g., each SI block of or group of SI elements, e.g., which may be configured at the WTRU. The list of configurations may enable a wider range of configurations and flexibility, e.g., as compared to a list including all the SI elements.

In response to the WTRU receiving the first signaling (e.g., first signature), the WTRU may map the first signaling to the SI block or elements to be updated and may (e.g., then) use the corresponding list to map following signatures.

One advantage of this may be that if one block or one group of elements is updated in the system (e.g., only one block or one group of elements is updated in the system), the SI update may be achieved using 2 signature transmissions (e.g., only 2 signature transmissions).

A WTRU may be configured to receive multiple signatures, e.g., wherein a first signature indicates one or more specific SIBs to be updated and a second signature indicates an index to a preconfigured set of SI configuration to be used for the signaled SIB(s) retrieval.

The WTRU may be configured to receive multiple signatures, e.g., wherein a first signature indicates a preconfigured set of SI configuration to be used for a second signature and a second signature indicates an index to the preconfigured set of SI configuration to be used for the signaled SIB(s) retrieval.

Identification of ULP support with Uu may be implemented.

As a condition for activating the ULP idle mode, the WTRU device may determine whether the serving cell is supporting ULP. One or more ways may be used to identify whether the cell supports ULP or not. One or more of the following may apply.

To determine whether ULP is supported, a WTRU may check whether a Uu SIB1 (e.g., configured according to description(s) herein) includes a configuration for ULP-SIB scheduling. For example, the WTRU device may determine the ULP support based on the presence of scheduled ULP-SIB in the schedulingInfoList and/or si-SchedulingInfo in SIB1. If not present, is the WTRU may determine that the Uu cell is not supporting ULP. If present, the WTRU may determine the ULP cell IDs of ULP cells configured in the ULP-SIB for cells that support ULP.

A WTRU device may determine ULP support based on correspondence between the ULP cell ID (e.g., obtained through sensing the LP-SS) and the ULP cell ID in the list of configured ULP Cells (e.g., obtained through Uu ULP-SIB).

To determine whether ULP is supported, a WTRU may determine whether there are dedicated indicator(s) in the MIB and/or SIB1.

Including dedicated indicator(s) in the MIB may be a costly operation (e.g., because the MIB may include few bits (e.g., only) and may need to be reliable and backwards/forward compatible as much as possible). Including dedicated indicator(s) in the MIB may enable the system to have dedicated SIB1 formats to include ULP specific information (e.g., without blind decoding several possibilities for ULP information). Including dedicated indicator(s) in the MIB may allow a faster identification of the ULP support.
A WTRU device may determine the support for ULP operations with Uu, e.g., through reading the MIB content. A dedicated bitflag representing the ULP support may be added to the (e.g., existing) MIB format, e.g., using a spare bit of MIB.
Including a dedicated indicator for ULP support may be implemented in SIB1 (e.g., as a bitflag), e.g., in the case where the ULP SI are transmitted as a ULP-SIB over Uu. In that case, the SIB1 may (e.g., only) indicate the support and the WTRU may obtain the remaining configurations over a ULP link and/or over a RRCReconfiguration message.
A WTRU device may determine the support for ULP operations with Uu, e.g., through reading the SIB1 content. A dedicated bitflag representing the ULP support may be added to the (e.g., existing) SIB1 format. In response to decoding of SIB1 and/or reading this bit information, the ULP support may be identified.

Support for feature(s) (e.g., further specific features) may be determined, e.g., from reading the content of the ULP SIB configuration and/or WTRU capabilities. For example, such feature(s) may include the incremental updates, on-demand ULP updates with Uu assistance, and/or successive update or specific indication features.

During the identification of supported features, the WTRU may determine the ULP-related features that are supported by the network, e.g., via reading the configurations received over SIB or RRC. Such features may include the way the SIBs are to be updated, e.g., using direct signatures, incremental updates, on-demand updates, etc.

SI update may be split between ULP and traditional interfaces (e.g., Uu interfaces).

The network may configure in SIB1 how the other SIBs may be received, including scheduling and/or their periodicity aspect or on-demand aspect. The scheduling/on-demand aspects of different SIBs may differ. Different SIBs may have difference sizes. The importance different SIBs may have in the system may be different.

A configuration may indicate which SIBs are configured to be acquired and/or updated over which interface. The SIBs may be acquired or updated via a Uu or ULP interface, e.g., as indicated by the configuration.

The configuration may be included in SIB1. The indication may be added (e.g., specifically) for a scheduled SIB (e.g., each of the scheduled SIBs) in SIB1. In some examples, some (e.g., sets) of SIBs may be acquired/updated via a traditional receiver and other SIBs may be acquired/updated via a ULP receiver.

The split of SIB handling may be configured in the ULP-SIB. In response to the ULP-SIB being signaled to the WTRU, the WTRU may be able to determine which SIB is to be handled by which interface/receiver. The split of SIB handling may have an advantage of not changing the legacy SIB1 (e.g., better backwards compatibility). For example, the WTRU may be configured to first acquire the SIBs (e.g., initially) with the default or traditional interface/receiver, and the WTRU's operation via a ULP receiver may apply to the updates (e.g., only the updates, such as the signatures described herein used to update a selected baseline configuration).

The configurations described herein may operate in conjunction with (e.g., come in addition to) a configuration indicating whether a SIB is periodic or on-demand. For example, the network may configure some SIBs to be ULP and on-demand. Extra procedures associated with SIBs being configured to ULP and on-demand are described herein.

If configured to receive Uu SIBs, the ULP receiver may be configured with several IEs (e.g., similarly with that of the Uu SIB1 so that the ULP receiver may (e.g., correctly) receive the SIBs). For example, the ULP receiver may be configured with the information associated with (e.g., regarding) the availability and/or scheduling (e.g., a mapping of SIBs to SI message in a schedulingInfoList, a periodicity, a SI-window size) of other SIBs, wherein the information may include an indication whether one or more SIBs are provided on-demand (e.g., only provided on-demand).

A determination of which interface/receiver to use may be based on one or more of the following. The determination may be based on the overhead the interface/receiver may represent, e.g., a size of the SIB, a size of a potential list of preset configurations to handle (e.g., sufficient) configuration alternatives, etc. The determination may be based on whether the SIBs are configured to be on-demand or periodic. For example, if the network or some of the devices do not support Uu assisted on-demand ULP SIB update, the on-demand ULP SIB update may (e.g., only) be carried over the Uu interface.

In examples, the ULP receiver may be configured to receive (e.g., wherein configured to receive may include receiving as used herein) all the SIBs over the ULP interface. In examples, the ULP receiver may be configured to receive the ULP-SIB (e.g., only the ULP-SIB) over its interface. In examples, the ULP receiver may be configured to receive part (e.g., only part) of the Uu SIB over the ULP interface and the Uu receiver may be configured to receive the remaining part (e.g., over the Uu interface). For example, the ULP receiver may be configured to handle the reception of SIB 1 to SIB 5 and the Uu receiver may be configured to handle SIB 6 to 14. In response to obtaining this configuration, the WTRU acquiring an SI update signaling may identify which interface/receiver to use based on (e.g., using) this configuration (e.g., instead of explicit signaling).

Acquisition procedure(s) and update procedure(s) for indexed system information may be implemented. Procedures supporting periodic and/or on-demand system information acquisition and updates using a ULP receiver may be implemented. Pre-set system information baselining and incremental update procedures may be implemented.

Acquisition procedure(s) for indexed system information may be implemented. System information may be used by (e.g., may be required for) a WTRU to determine eligibility of camping on a specific cell and/or to be able to perform initial access to the network. The WTRU may utilize a traditional receiver to acquire a (e.g., current) Uu serving cell's system information to be used (e.g., required) for initial access to the network; may acquire system information sets valid within a defined area covered by multiple cells; and/or may utilize a ULP receiver to determine the system information set valid for the (e.g., current) Uu/ULP serving cell. In some examples, the WTRU may utilize the ULP receiver to determine a system information set that is valid for the (e.g., current) serving Uu/ULP cell, e.g., using default pre-set system information set(s) and/or a system information signature detectable by the ULP receiver.

Procedure(s) for SI initial acquisition may be implemented.

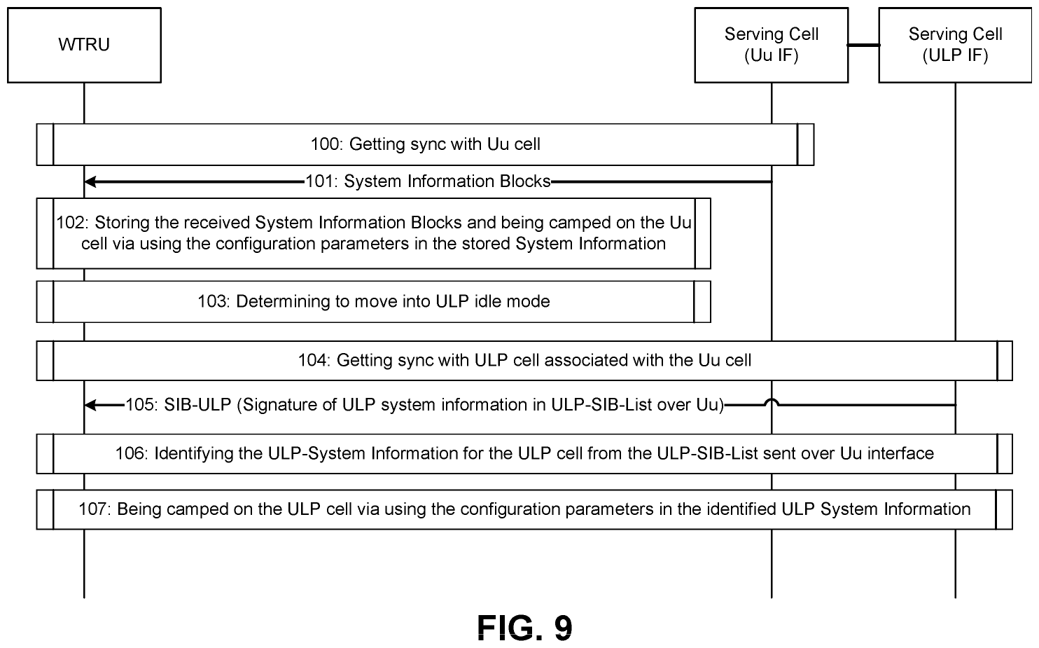

FIG. 9 illustrates an example system information acquisition procedure performed by a WTRU in IDLE/INACTIVE state using a ULP receiver via signatures. The example system information acquisition procedure may be a procedure of how a WTRU may acquire system information sets (e.g., using a traditional receiver) to assist the ULP receiver in determining a serving cell's system information (e.g., during IDLE/INACTIVE state mobility) and/or to be camped on a ULP receiver serving cell utilizing SI signature signaling.

The WTRU may perform one or more of the following actions. At 100, the WTRU may perform cell search and may attempt getting synchronization with a found Uu cell, which may satisfy the cell selections criteria. At 101, the WTRU may acquire system information for the Uu cell, e.g., after a sync. At 102, the WTRU may store the received system information and may be camped on the Uu cell, e.g., via using the configuration parameters given by the stored system information. At 103, the WTRU may determine an interest in/criteria for moving to ULP idle mode state. At 104, the WTRU may attempt getting sync with a ULP cell associated with the Uu cell. The associated ULP cell information may be given by System Information received from the Uu cell or a (e.g., dedicated) RRC message (e.g., a RRCReconfiguration message). At 105, the WTRU may receive SIB-ULP, which may be sent from the ULP cell. At 106, the WTRU may identify the ULP System Information for the ULP cell, which may be sent from the ULP-SIB-List over the Uu interface (e.g., System Information sent from Uu cell or a dedicated RRC message.) At 107, the WTRU may be camped on the ULP cell, e.g., via using the configuration parameters in the identified (e.g., at 106) ULP system information.

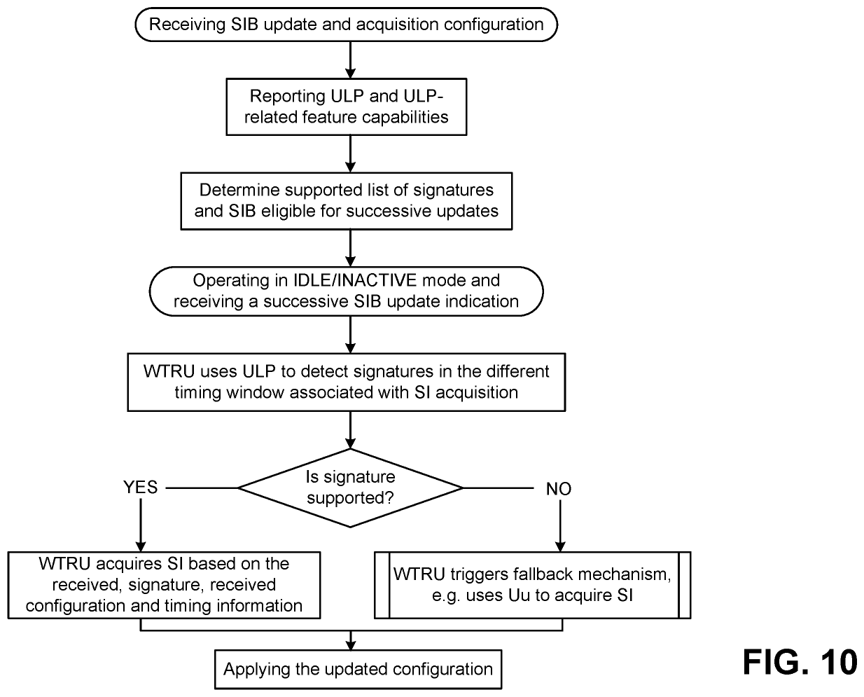

Different WTRUs may have different capabilities, e.g., in terms of a number of supported signatures. For example, a first WTRU may support the monitoring (e.g., consistent monitoring) of six signatures and a second WTRU may support the monitoring (e.g., consistent monitoring) of ten signatures. To accommodate the different WTRU capabilities, e.g., based on desired behavior/requirement for power consumption, the network may use assignment of one of the signatures supported by the first WTRU to indicate an unsupported signature signaling. In some examples, the first WTRU may (e.g., be required to) detect an unsupported signature without the help of the network, e.g., detecting the absence of a supported signature during a configured window. An example of this scenario is illustrated in FIG. 10.

FIG. 10 illustrates an example procedure of SI acquisition with Uu-assisted configuration and successive SI signaling over ULP. The example procedure of SI acquisition may be a procedure of how a WTRU may acquire system information sets (e.g., using the traditional receiver) to assist the ULP receiver in determining serving cell's system information (e.g., during IDLE/INACTIVE state mobility) as described herein and/or to be camped on a ULP receiver serving cell utilizing timed/hierarchical SI signature signaling. The WTRU may perform one or more of the following actions. The WTRU may receive a (e.g., current) serving cell's system information, e.g., using the traditional receiver, and may determine initial access parameters and/or support of ULP receiver's timed/hierarchical SI acquisition (e.g., for a group of cells in a defined area). The WTRU may utilize initial access parameters to report ULP receiver capability. The WTRU may request scheduling/signaling of indexed system information sets and/or a mapping to ULP receiver's supported signatures. The WTRU may receive the indexed system information sets, system information signaling hierarchy, and/or mapping information. The WTRU may utilize the ULP receiver for IDLE/INACTIVE state mobility and/or indexed system information acquisition. The ULP receiver may detect the beginning of a hierarchical system information interval, e.g., using a configured signature. The WTRU may utilize timing/hierarchical information and/or a mapping between supported signatures and system information sets, e.g., to retrieve/update the system information of the (e.g., current) serving cell (e.g., using the ULP receiver). For example, the WTRU may utilize a first signature, which may be detected within a first duration T from the detection of the configured signature, to retrieve a first block of system information elements from the fifth pre-set system information set. The WTRU utilize a second signature (e.g., the same as or different from the first detected signature), which may be detected within a second duration T that follows the first duration T from the detection of the configured signature, to retrieve a second block of system information elements from the seventh pre-set system information set. The selection of the fifth and seventh system information sets may be based on the mapping between supported signatures and system information sets. The retrieved block of system information elements from the selected system information set may be dependent on when the signature is detected based on the signaled hierarchical information. In some examples, the first duration may be used to indicate the update for SIB3 and the second duration may be used to indicate the update for SIB5. An update duration T, which may be within an update period Ñ T for Ñ different system information blocks or group of blocks, may include one or more OFDM symbols, slots, and/or subframes.

The WTRU may detect a non-supported signature, e.g., within the N^{th} duration of the hierarchical interval corresponding to the N^{th} block of system information elements (e.g., in the case the WTRU does not detect the beginning of a hierarchical system information interval using a configured signature). Determining the detection of the non-supported signature may be an alternative decision to determining whether a signature is supported as illustrated in FIG. 10. The detection of the non-supported signature may be based on a failure to detect a supported signature, e.g., within the N^{th} duration allocated to the N^{th} block of system information elements. By the physical properties of the signatures, if a non-supported signature is sent to a ULP receiver, the receiver may not be able to detect a non-supported signature. A non-supported signature may be perceived as the absence of signature in a predefined time window and the absence may be interpreted as an unsupported signature. In some examples, the detection of the non-supported signature may be based on the detection of WTRU/group/globally-assigned signature for detecting non-supported signatures and/or failure to detect any other supported signature within the N^{th} duration of the hierarchical interval. In response to an unrecognized or unsupported signature being detected, a fallback procedure may be triggered to acquire the SI. For example, the WTRU may wake up its traditional radio, may synchronize it (e.g., if necessary), and may perform the full or partial SI acquisition. One way to perform the partial SI acquisition may be to use the information obtained from the ULP SI procedure (e.g., the timing of where an unsupported event occurred) to determine which SI or SI block was being updated, and the traditional radio may transmit a specific SI request if supported by the network.

The network may repeat the transmission, e.g., if the network transmits the signature to the WTRUs in specific time windows. Based on the repeated transmission, ULP receivers may increase the chance of correct reception of the signature. The ULP receiver may use the reception of several signatures to verify the expected SI update and/or to accumulate the received signal to increase the signal quality.

If the network transmits the signature to WTRUs in configured time windows and if the network is aware that at least one WTRU does not support the signal it will transmit, the network may send successively/iteratively an unsupported signal signature and the signature for the SI acquisition/update.

In some examples, a WTRU may acquire an initial system information set for the (e.g., current) serving cell (e.g., using the ULP receiver) utilizing a default pre-set system information sets and a mapping to ULP receiver detectable signatures. The WTRU may use pre-set (e.g., specification defaults) configurations and may determine initial access parameters and/or support of ULP receiver's timed/hierarchical SI acquisition for a group of cells in a defined area. The WTRU may utilize the ULP receiver for IDLE/INACTIVE state mobility and/or indexed system information acquisition. The ULP receiver may detect a timing-free signature, which may be a signature that may be transmitted (e.g., at any time) without using (e.g., a need for) a time reference, e.g., a synchronizing signal, a slot number, a frame number, etc. The WTRU may map the received signature to the SI blocks or elements (e.g., according to the pre-set/default mapping configuration) and may apply the corresponding configuration. For example, the preset configuration may indicate that some signatures are assigned to an element (e.g., each element) of a list of ULP SI configurations. The network may transmit a signature that corresponds to a third ULP SI configuration. The WTRU device may use the third configuration of the configuration list and may apply it to the ULP receiver.

The examples described may refer to time domain windows to receive different signatures. As a person skilled in the art may appreciate, the examples may apply to frequency and/or time domain reception of signatures (e.g., SIB index) being used to indicate and map to the corresponding content.

Procedure(s) for supporting on-demand SI Acquisition (e.g., via a ULP receiver) may be implemented.

In a RAT (e.g., NR), the SIBs may be configured to be periodical or on-demand. On-demand SIBs may not be transmitted to the users unless they have been requested by the user. This may be intended to minimize the overhead and/or on-time of the radio in the system.

MIB and SIB1 may be periodical (e.g., always periodical) as they may be necessary for Uu users to operate and/or initiate connections. Other SIBs may be configured and the configuration of whether a SIB is periodic or on-demand may be indicated in SIB1. SIB1 may include information associated with (e.g., indicating) the availability and/or scheduling (e.g., a mapping of SIBs to SI message, a periodicity, a SI-window size) of other SIBs, e.g., wherein the information may include an indication whether one or more SIBs are provided on-demand (e.g., only provided on-demand) and, if a SIB is provided on-demand (e.g., only provided on-demand), the information may include the configuration to be used by the WTRU to perform the SI request.

The ULP receiver may not be capable of transmission. To perform the on-demand SIB acquisition, the WTRU may wake up its Uu transmitter and may send the SIB request via the Uu transmitter.

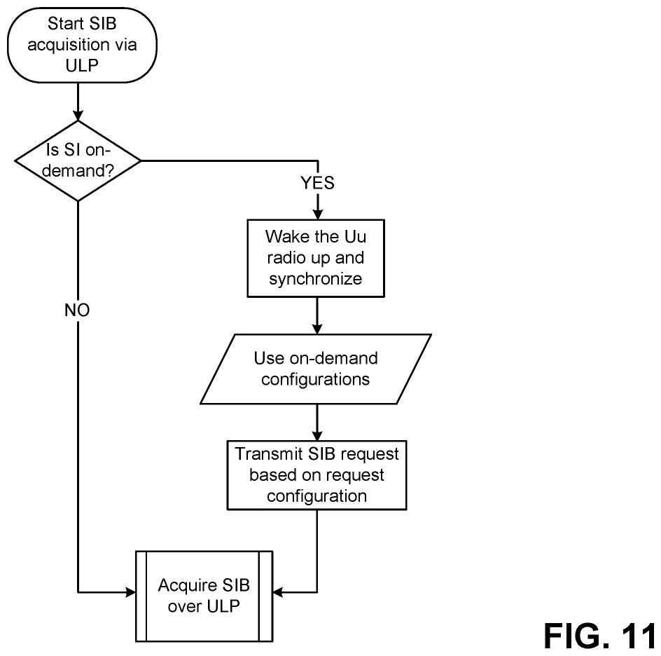

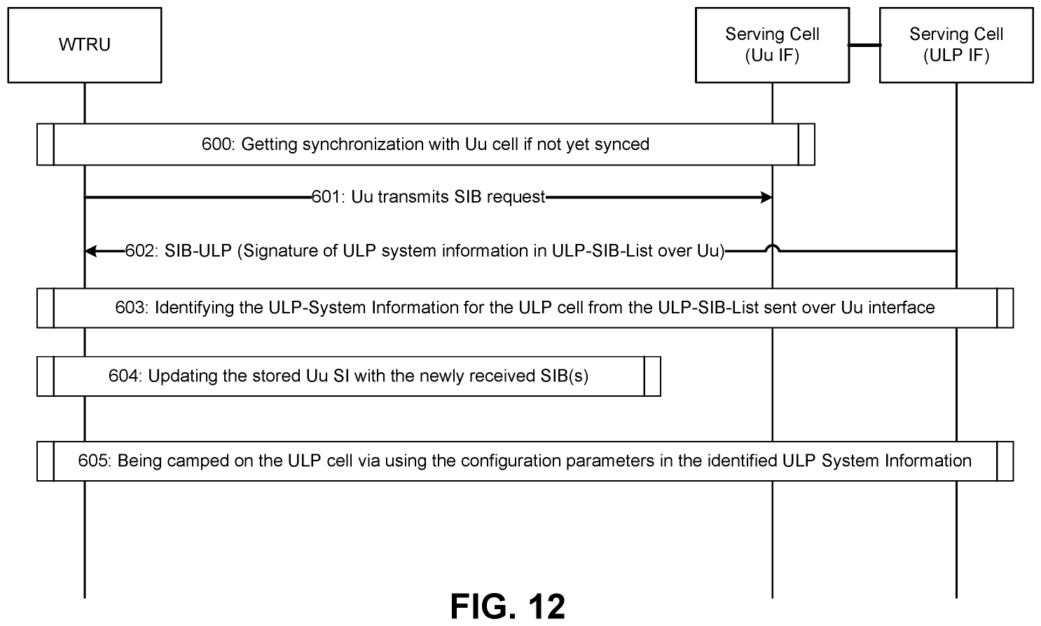

FIGS. 11-12 illustrate an example of on-demand ULP SI acquisition assisted by Uu transmission. The WTRU may perform one or more of the following actions. The WTRU may be configured to receive an on-demand SIB using ULP receiver. In response to determining to receive the on-demand SIB, the WTRU may wake up the Uu transmitter, establish synchronization (e.g., if necessary) and prepare to transmit the SIB request, e.g., based on the request configuration. In response to reception of the request, the network may transmit the corresponding SIB over the ULP link. The WTRU via the ULP receiver may monitor and/or receive the SIB, e.g., over the configured search spaces.

The on-demand SI acquisition may be triggered if the WTRU detects that desired SIB updates and/or an acquisition are/is missing from the (e.g., on-going) procedure. For example, in the case that the SI change notification indicates which following SIBs are to be updated, and if the WTRU was not able to detect/decode the desired SIB in the on-going procedure, the WTRU may perform an on-demand request to (e.g., further) be able to receive the SIB.

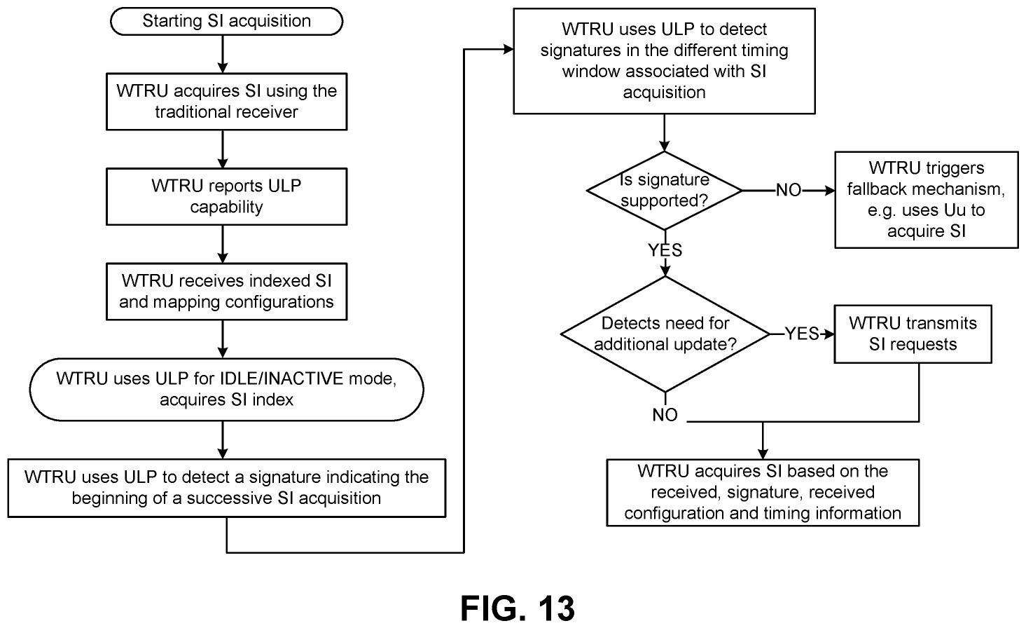

FIG. 13 illustrates an example procedure of successive and on-demand SI acquisition with Uu assistance. The example procedure may be a procedure of how a WTRU may acquire on-demand blocks of system information elements (e.g., using the ULP receiver), for example while performing IDLE/INACTIVE state mobility and utilizing timed/successive SI signature signaling. The WTRU may perform one or more of the following actions. The WTRU may receive a serving cell's (e.g., current serving cell's) system information, e.g., using the traditional receiver and may determine initial access parameters and/or support of ULP receiver's on-demand and successive SI acquisition, e.g., for a group of cells in a defined area. The WTRU may utilize initial access parameters to report ULP receiver capability and/or to request scheduling/signaling of indexed system information sets and/or a mapping to ULP receiver's supported signatures. The WTRU may receive the indexed system information sets, system information signaling hierarchy configuration, and/or mapping information. The WTRU may utilize the ULP receiver for IDLE/INACTIVE state mobility and/or indexed system information acquisition. The ULP receiver may detect the beginning of a successive system information interval and may determine a mapping between interval durations/slots and blocks of system information elements, e.g., based on a detected configured signature. The WTRU may utilize timing and/or successive information and/or a mapping between supported signatures and system information sets, e.g., to retrieve and/or update determined blocks of system information elements for the serving cell (e.g., current serving cell), for example using the ULP receiver. The WTRU may determine (e.g., the need) to acquire a different block of system information elements, e.g., based on its capability or detection of a system information change notification. The WTRU may utilize the initial access parameters to request a block (e.g., desired block) of system information elements. The WTRU may receive scheduling information and may utilize the traditional receiver and/or ULP receiver to receive the desired block of system information elements.

The WTRU may detect a non-supported signature, e.g., within the Nth duration of the hierarchical interval corresponding to the Mth block of system information elements (e.g., in the case the WTRU does not detect the beginning of a successive system information interval and/or determine a mapping between interval durations/slots and blocks of system information elements, e.g., based on a detected configured signature). The detection of the non-supported signature may be based on a failure to detect a supported signature, e.g., within the Nth duration allocated to the Mth block of system information elements. In some examples, the detection of the non-supported signature may be based on the detection of WTRU/group/globally-assigned signature for detecting non-supported signatures and/or failure to detect any other supported signature within the Nth duration of the hierarchical interval.

Procedure(s) for system information reconfiguration and/or system information update may be implemented.

Due to the limited number of signatures that may be supported by the ULP receiver, the number of pre-set or initially signaled system information sets may be limited and may not cover all possible combinations of system information parameters. The network may (e.g., plan or be prepared to) use a configuration that is not currently listed in the users' (pre) configuration. Methods that may enable modifying and/or updating the configurations may be used and the network may have (e.g., more) flexibility in selecting SI configurations that are not already stored in the users (pre) configuration set.
Two types of updates may be implemented, e.g., to enable system flexibility.

Using an implementation of a first type of update, in response to a user obtaining some sets of configurations, for example through (pre-) configuration, the network may be capable of modifying and/or updating the pre-set or initially signaled system information. The set of configurations stored at the user side may be updated to reflect and/or support dynamic configuration changes from the network.

Using an implementation of a second type of update, in response to a user having been (e.g., initially) assigned some SI configuration sets, the network may be able to update the configuration to be used by the user, e.g., by altering specific IEs on top of the baseline configuration set. This may provide a finer granularity of configuration and the network may send specific and/or detailed updates for the IE or SI parameters that are not already configured.

A selection of which type of update to perform may be based on whether the configuration update is (e.g., expected to be) permanent or long lived (e.g., which may indicate that it is better to update the list of configurations in users' (pre)configuration), or if the modification is temporary. In some examples, to determine the type of update, the WTRU may identify the expected (e.g., necessary) overhead to obtain the desired configuration. If the modification of a baseline configuration with specific elements is expected to use (e.g., requires) too much overhead, e.g., especially on the ULP interface, it may be preferable to perform a change in the configured sets of configurations, e.g., indicate, for example, a baseline (e.g., a new baseline) that may require less overhead to update (e.g., for this time and afterwards).

Reconfiguration of the (pre-)configured set(s) of SI configuration may be implemented. If the network determines to perform a reconfiguration of the sets of SI configurations available for selection, the network may indicate the change to the devices, e.g., through a signaling that initiates the procedure. For example, a dedicated signature may be sent over the ULP interface indicating such SI sets reconfiguration. Upon detecting this indication, the WTRU may follow procedure(s) described herein to perform the SI update, e.g., over the Uu and/or the ULP interface.

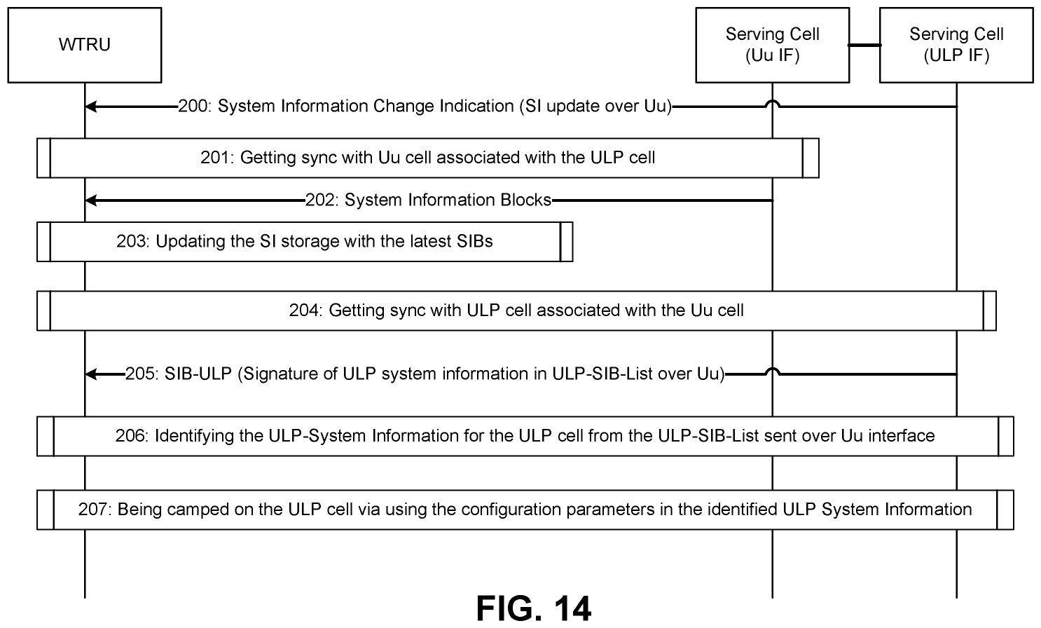

FIG. 14 illustrates an example ULP system information update procedure. The example procedure may be a procedure of how a WTRU update system information sets using the traditional receiver to assist the ULP receiver in acquiring set(s) of configurations (e.g., baseline configurations) if the WTRU is camping on the ULP cell.

The WTRU may perform one or more of the following actions. At 200, the WTRU may receive an indication signaling the update of the system information (e.g., via Uu interface), and may determine to obtain the update of the SI from the Uu cell associated with the (e.g., current) serving ULP cell, e.g., via a wake-up signal or paging indication.

At 201, the WTRU may synchronize with the Uu cell associated with the ULP cell. At 202, the WTRU may acquire the system information blocks (SIBs) updated as part of the system information update procedure (e.g., the current system information update procedure, for example, via the network.
At 203, the WTRU may update stored system information with received and/or updated SIBs.
At 204, the WTRU may synchronize with a ULP cell associated with the serving Uu cell (e.g., wherein the Uu cell-ULP cell association information may come from system information sent from the Uu cell or a dedicated RRC message).
At 205, the WTRU may acquire a SIB-ULP sent from the synchronized ULP cell. The SIB-ULP may include a signature, which may be used to identify the ULP System Information corresponding to the ULP cell.
At 206, the WTRU may identify the ULP system information corresponding to the ULP cell sent from the ULP-SIB-List over Uu interface (e.g., system information being sent from Uu cell or a dedicated RRC message) with the signature given by the SIB-ULP sent from the ULP cell.
At 207, the WTRU may be camped on the ULP cell, e.g., using the configuration parameters in the identified ULP system information.

If the WTRU receives an indication of SI change (e.g., as described herein), the received indication of SI change (e.g., the signal sent) may indicate a simple change in SI and the WTRU may determine to use (e.g., require) the traditional receiver to acquire the SIBs (e.g., all the SIBs) from the network as part of the ongoing SI update procedure, e.g., without knowing in advance which SIB is to be updated. The WTRU (e.g., via the traditional receiver) may acquire the SIBs that the network sends to the device. If some SIBs are determined for (e.g., require) on-demand requests, the traditional transceiver may perform the request (e.g., as described herein).

In some examples, the ULP SI Change indication that is used to indicate an incoming SI update procedure may include an indication of which SIBs or group of SIBs are being updated. In examples, the indication may be limited to a binary option, such as to specify if the updates concern a specific SIB and/or, in a particular example, if this is about the ULP-SIB (e.g., the signal may indicate whether the update is for the ULP-SIB or for some other SIB(s)). In examples, an indication may signal more than one specific SIBs to be updated, such as a list of SIB1, ULP-SIB, and other SIBs. In examples, an indication may signal one or more IE or group of IEs to be updated. More than one grouping combinations may be implemented.

The WTRU device, e.g., in response to receiving such indication, may determine which SIB(s) are to be updated, e.g., according to the received SI change indication and/or its device capabilities (e.g., not all devices receive SIB for Sidelink or for positioning). The WTRU may proceed with the SI update procedure, e.g., using the traditional receiver as detailed in the following. If some SIB(s) are determined for (e.g., require) on-demand requests, the traditional transceiver may perform the request.

The WTRU may perform one or more of the following actions. At 200′, the WTRU may receive an indication signaling the update of the system information via Uu interface, and may determine to obtain (e.g., require) the update of the SI from the Uu cell associated with the (e.g., current) serving ULP cell, e.g. via a wake-up signal or paging indication. The indication may (e.g., further) include a selection of which SIBs are to be updated.

At 201′, the WTRU may synchronize with the Uu cell associated with the ULP cell.
At 202′, the WTRU may acquire the system information blocks (SIBs) updated as part of the system information update procedure (e.g., the current system information update procedure), for example via the network.
At 203′, the WTRU may update the stored system information with received and/or updated SIBs.
At 204′, the WTRU may synchronize with a ULP cell associated with the serving Uu cell (e,g., wherein the Uu cell-ULP cell association information may come from system information sent from the Uu cell or a dedicated RRC message).
At 205′, the WTRU may acquire the SIB-ULP sent from the synchronized ULP cell. The SIB-ULP may include a signature, which may be used to identify the ULP system information corresponding to the ULP cell.
At 206′, the WTRU may identify the ULP system information corresponding to the ULP cell from the ULP-SIB-List sent over Uu interface (e.g., via system information sent from Uu cell or a dedicated RRC message) with the signature given by the SIB-ULP sent from the ULP cell.
At 207′, the WTRU may be camped on the ULP cell, e.g., using the configuration parameters in the identified ULP system information.

The signature may indicate the ULP SI corresponding to the serving ULP cell and/or the ULP SI and the SI corresponding to the associated Uu cell. In some implementations, the ULP cell and the associated Uu cell may be the same physical cell.

The scheduling information for specific SIB(s) may be included in the indication signal and/or in a separate message following the indication. This scheduling method may represent a cross-cell scheduling mechanism. This cross-cell scheduling method may be applied not only for SI update but also for regular DL data reception at Uu cell.

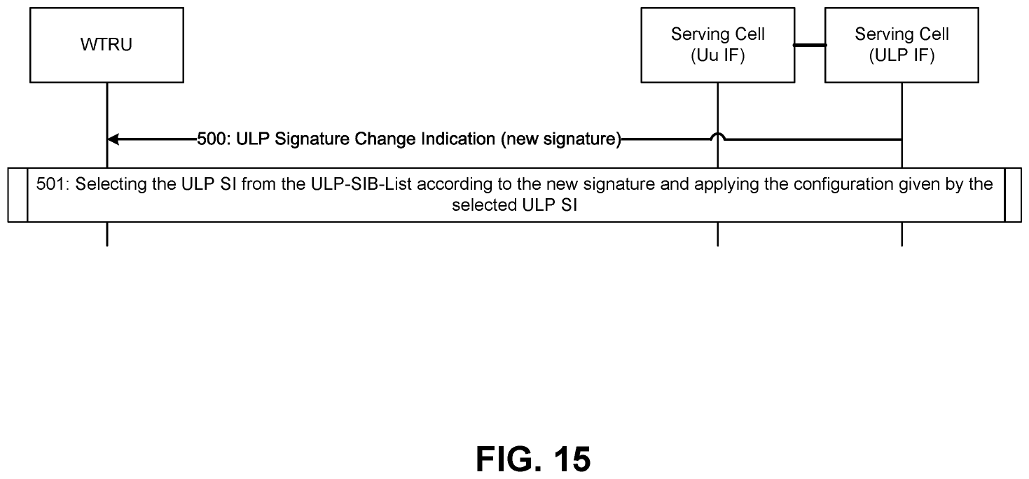

The ULP interface may (e.g., in a form of SI update) be used to transmit the signature corresponding to the selection of a set of configurations for given SIB(s) (e.g., a new set of configurations for given SIB(s), for example, in particular for the ULP-SIB. The WTRU device, e.g., having received lists of possible configurations for the different SIBs, may detect the signature and may determine the corresponding configuration. The WTRU may (e.g., in response) apply the corresponding configuration to the device. In the example of ULP-SIB update, e.g., as illustrated in FIG. 15, the ULP receiver may apply the configuration (e.g., new configuration) and the WTRU may camp on the ULP cell. If the SIB update corresponds to the traditional SIB, the WTRU may apply the configuration to the camped Uu receiver.

FIG. 15 illustrates an example procedure of change of ULP SI signature. The WTRU may perform one or more of the following actions. At 500, the ULP cell may signal a signature (e.g., a new signature) corresponding to the ULP-SIB-List given by the serving Uu cell, e.g., via a ULP SI Signature Change indication. The ULP SI signature change indication may be sent via wake-up signal (WUS), via paging indication or via LP-DCI. At 501, the WTRU may re-select the ULP SI from the ULP-SIB-List given by the serving Uu cell, e.g., according to the signature and may apply the configuration given by the selected ULP SI.

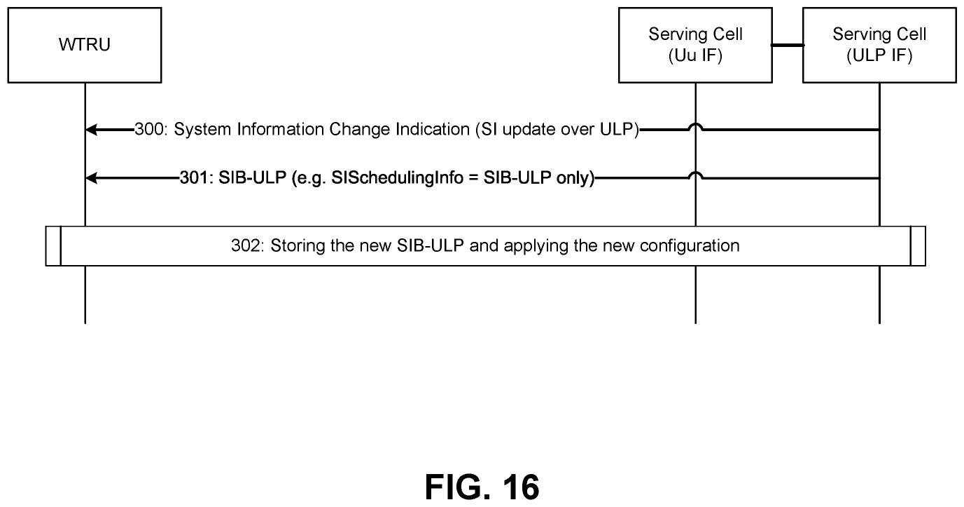

FIG. 16 illustrates an example SIB-ULP update procedure over a ULP interface. The example procedure may be a procedure of how a WTRU updates system information sets using the ULP receiver to acquire a set of configurations (e.g., changed or new set of configurations), for example if the WTRU is camping on the ULP cell. The SI change indication may provide the option to use the ULP interface to update the SI. The SI change indication may indicate that the ULP-SIB is the SI (e.g., SIB) that is determined to be updated (e.g., requires update). In a following signal that may be a signature, the network may use the ULP interface to indicate which ULP-SIB configuration is to be used. The network may have previously indicated a list of possible ULP-SIB to be chosen and the WTRU may have stored the list (e.g., a mapping between signatures and the possible ULP-SIB configuration). The mapping may come from the received signal, which may include or may be the information that the ULP-SIB is to be updated and the list of possible ULP-SIB configuration acquired previously by the WTRU. This method may enable a switch or change in the (pre)configured set of possible configurations.

The WTRU may perform one or more of the following actions. At 300, the WTRU may receive an indication signaling an update of the system information (e.g., via the ULP interface), e.g., via a wake up signal or paging indication.

At 301, the WTRU may receive a SIB-ULP (e.g., new SIB-ULP), may check the SI scheduling information, and/or may acquire the updated SI, e.g., via the ULP receiver.

At 302, the WTRU may store the configuration in the received SIB-ULP and may apply the configuration.

In some examples, the ULP cell may transmit (e.g., first transmit) a signal to indicate a SI change that may be incoming, and the signal may indicate that the following update may use explicit data. The ULP receiver may synchronize with the ULP cell, for example using the ULP-RS (e.g., if necessary). The network may (e.g., then) transfer the corresponding update (e.g., via ULP interface) with explicit data, which may be decoded by the ULP receiver device. The explicit data may include the set of IEs or SIBs to be updated. The capacity of the ULP may be lower than that of Uu interface. The SI maximum packet size may be lower than the maximum SI packet of Uu. Several packets may be needed. It may be possible to transmit several explicit SI update packets if a single ULP data packet cannot carry enough payload.

In some examples, reconfiguration of the SI sets stored at the WTRU may be triggered by mobility and/or changes of cells/location. For example, the reconfiguration may be triggered if a radio notification area update (RNAU) or tracking area update (TAU) procedure is triggered. The SI configuration may be cell specific and may be related to a specific group of cells, e.g., tracking area, registration areas etc. If a WTRU that is located in or changing the tracking area or registration area is changing the cell, the SI shall be updated (e.g., accordingly). If the WTRU knows the SI configuration for the location (e.g., new location), for example, through pre-configurations or acquired SI configurations, the WTRU may apply the SI configuration of the location, e.g., corresponding to a received signature. If the WTRU does not know the SI configuration, the WTRU may trigger the SI acquisition from that location.

In some examples, the ULP-SIB may include the configurations to be applied over multiple ULP cells within the range or support of a given Uu cell. The configurations for ULP cells may be identical. To reduce the size to the ULP-SIB, one configuration may be sent with a list of ULP cells ID, wherein the configuration may be applicable and the cell ID identification may be sufficient to determine the corresponding SI configuration. If the WTRU detects that it is in the coverage of a ULP cell that matches the ULP cell ID in a corresponding configured/signaled ULP-SIB, the WTRU may apply the acquired configuration for ULP operations.

Although it is expected that within a given Uu cell or several nearby cells the configurations should be similar, it is also possible to use different configurations for different ULP cells.

In some examples, the ULP-SIB may include the configurations to be applied over multiple ULP cells (e.g., from a given or multiple Uu cells). The configurations for different ULP cells may differ from each other's. One way to send the configurations may be to send a list of individual configurations with the ULP cell ID as reference for each. One way may be to send a primary configuration and/or a list of differentiable configurations for each ULP cell with their respective ID. To know and transmit the configuration of nearby cells, the network may use cell coordination to share the information of the ULP configurations within its neighboring cells.

Incremental update(s) to a SI configuration(s) baseline may be implemented.

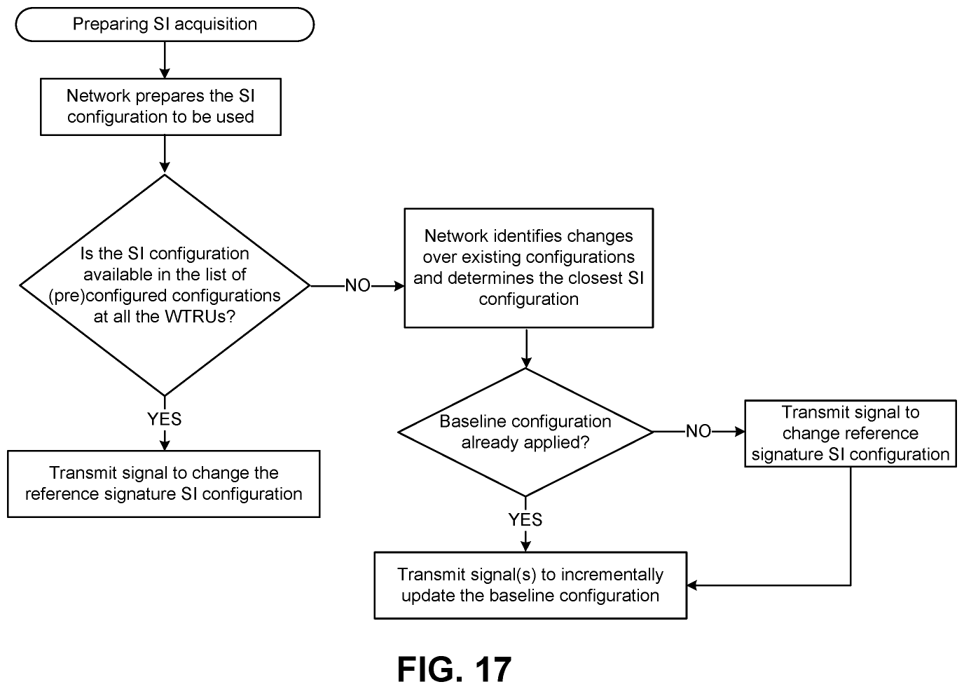

FIG. 17 illustrates an example network procedure to update SI including an incremental update of a SI configuration baseline. As illustrated, if the network is preparing to send an SI update, the network may determine whether the desired update configuration is stored at the WTRU's side, e.g., if the latest version of the SI configuration sets sent to the WTRUs includes the desired configuration. If the desired configuration is included in the latest version, an SI change or update may be performed, e.g., wherein a signature indicative of an SI configuration (e.g., new SI configuration) is sent and replaces a (e.g., currently) used configuration.

If the latest version of the SI configuration sets sent to the users/WTRUs does not include the desired configuration, the network may identify the difference between the desired configuration and the stored configuration available at the WTRU's side. The network may select the stored configuration that is the closest to the desired configuration. This configuration may act as a baseline for the incoming updates. In an example, the closest configuration may mean that the network selects the configuration under which the least overhead of specific IE/SIB updates may be expected (e.g., required). One method may be to determine the number of IEs to update, e.g., regardless of the difference in value between the desired and selected configurations.

If the baseline configuration is not the one used by the system (e.g., currently used by the system), the network may send (e.g., first send) a signal to indicate such baseline configuration. The network may send (e.g., further send) specific updates (e.g., additional specific updates). The IEs/SIBs included in these specific updates may replace the ones of the baseline configuration.

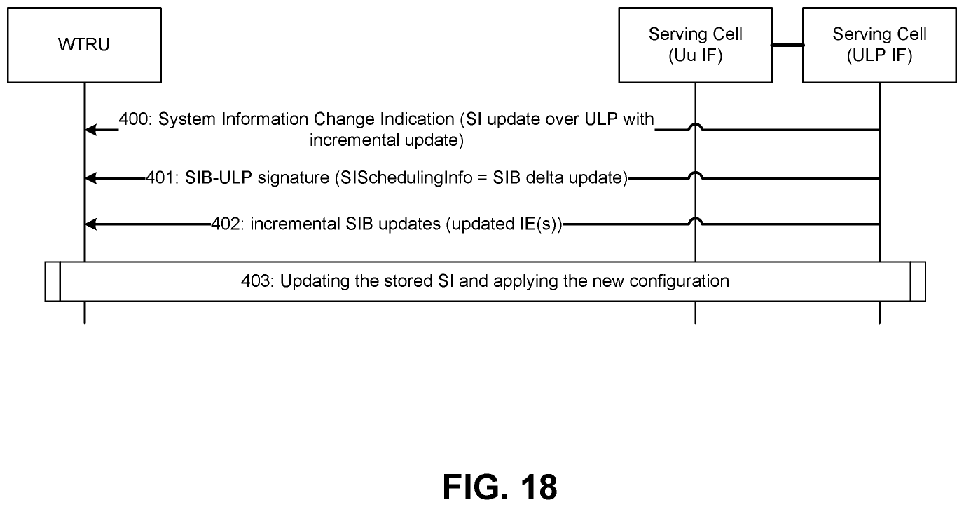

FIG. 18 illustrates an example signaling sequence for incremental SI update using delta SIB(s) using a ULP receiver. As illustrated, the SI may be updated using the ULP receiver, following the reception of a SI change indication. The ULP receiver may be limited in throughput. A hierarchical approach may be implemented, e.g., wherein the serving cell delivers SIB information using (e.g., first using) a complete SI information via a preconfigured signature mapping approach, and the ULP cell may (e.g., subsequently) transmit the difference (e.g., delta SIB(s)) between the signaled SI content and the desired configuration. The SI that is first sent may be chosen by the network, e.g., to minimize the overhead cost for the delta transmission. An indication of incremental update may be sent over the SI change indication signal or in the first/baseline SI indication. The delta configuration may be using signature mapping if configured or using (e.g., explicit) data indication. Being limited to a smallest change to an (e.g., existing) SIB configuration, it may be expected that a few IEs (e.g., only a few IEs) may be determined by the WTRU to be changed (e.g., require a change).

The WTRU may perform one or more of the following actions. At 400, the WTRU may receive an indication, e.g., via a signature/wake up signal or paging indication, signaling the update of the system information using a baseline configuration and incremental update signaling via the ULP receiver.

At 401, the WTRU may receive a signature, which may be indicative of a SI configuration set baseline (e.g., new SI configuration set baseline) from the sets of SI configurations in a pre-configured or signaled (e.g., received via the traditional receiver) ULP-SIB. The WTRU may determine the SI scheduling information and/or the one or more parameters in an SI configuration to be updated. The SI scheduling information may be determined based on a pre-configuration, e.g., a time offset with respect to when the baseline signature is received and preconfigured set of frequency resources, a received message following the reception of the baseline signature, and/or one of the SIBs included in the signaled baseline SI configuration.
At 402, the WTRU may receive the scheduled delta SIB(s), which may include the updated parameters corresponding to the IEs/SIBs in the baseline SI configuration set. The delta SIB may indicate what IE(s)/SIB(s) is/are included in the present delta SIB and/or the value(s) of the IE(s) (e.g., new value(s) of the IE(s)).
At 403, the WTRU may update the stored SI configuration set received from Uu cell (e.g., with the (e.g., newly) received information given by the delta SIB(s) and may apply the configuration).

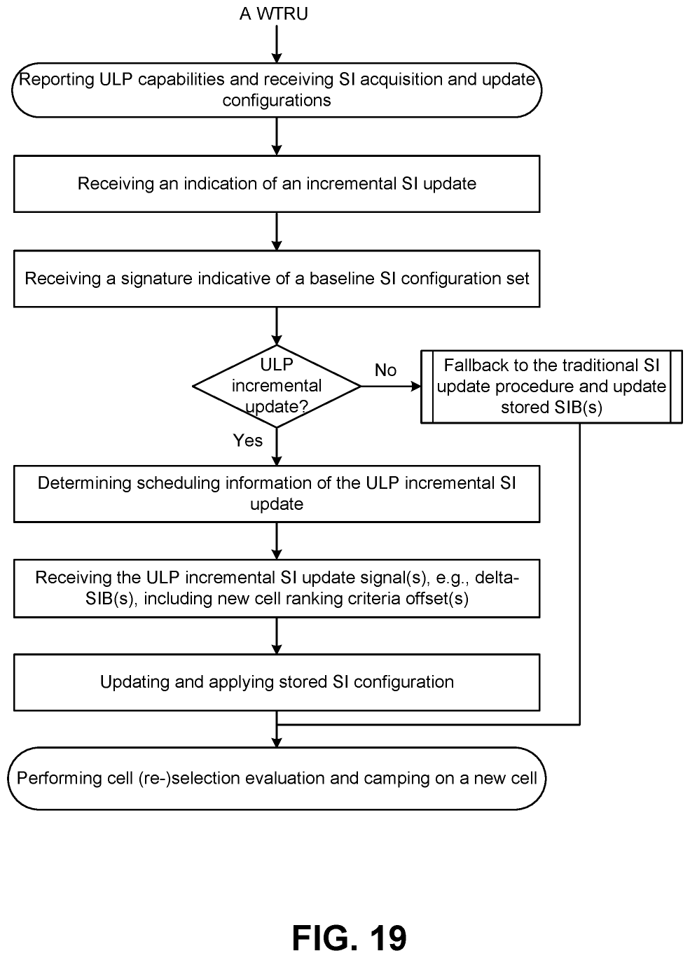

Incremental ULP SI updates may be implemented. FIG. 19 illustrates an example of a ULP receiver-capable WTRU performing ULP-based SI incremental updates. The WTRU may perform one or more of the following actions. The WTRU report ULP capability(ies) (e.g., to the network). The WTRU may receive SI acquisition and/or SI update configuration information. The WTRU may receive and may detect an indication for an incremental system information update (e.g., as described herein). The WTRU may receive a signature, which may indicate a baseline SI configuration (e.g., a selected baseline configuration, for example a selected baseline configuration from a set of baseline configurations) based on the received SI acquisition configuration. The WTRU may determine scheduling information of incremental SI update signals (e.g., based on the received incremental SI update indication (e.g., as a reference point) and the received SI update configuration, for example, to determine an offset (e.g., and frequency resources) from the reference point). The WTRU may receive the incremental SI update signals as described herein (e.g., signatures, delta-SIB(s), etc.), e.g., according to the determined scheduling configuration, which may in some examples include (e.g., any) intra-frequency offset(s) and/or inter-frequency offset(s) for cell ranking criteria. The WTRU may update SI configuration parameter(s), e.g., based on the determined SI configuration baseline, the received incremental SI updates, and/or the received SI update configuration. The WTRU may perform cell (re-) selection evaluation, e.g., based on the updated SI configuration (e.g., the cell ranking criteria offsets) and may camp on a cell (e.g., a new cell).

The SI acquisition configuration and/or SI update configuration may be received using system information (e.g., the system information acquired (e.g., via the main radio) in response to the WTRU powering up) and/or RRC signaling. The SI acquisition configuration and/or SI update configuration may be valid within a serving cell (e.g., current serving cell) and/or a set of cells in a defined area.

The SI acquisition configuration and/or SI update configuration may include one or more of a baseline SI configuration, support of incremental ULP-based SI update, a list of IEs and corresponding SIB(s) that are eligible for the incremental update, or an incremental update signaling format (e.g., a subset of bits in a baseline IE value to be replaced by the incremental update).

The detection of an indication of an incremental SI update may occur while the WTRU is operating in IDLE or INACTIVE, e.g., a ULP RRC IDLE state and/or a ULP RRC INACTIVE state.

The configuration for the incremental update may replace a configured value with a received value or may add a received value to the (e.g., already) configured value.

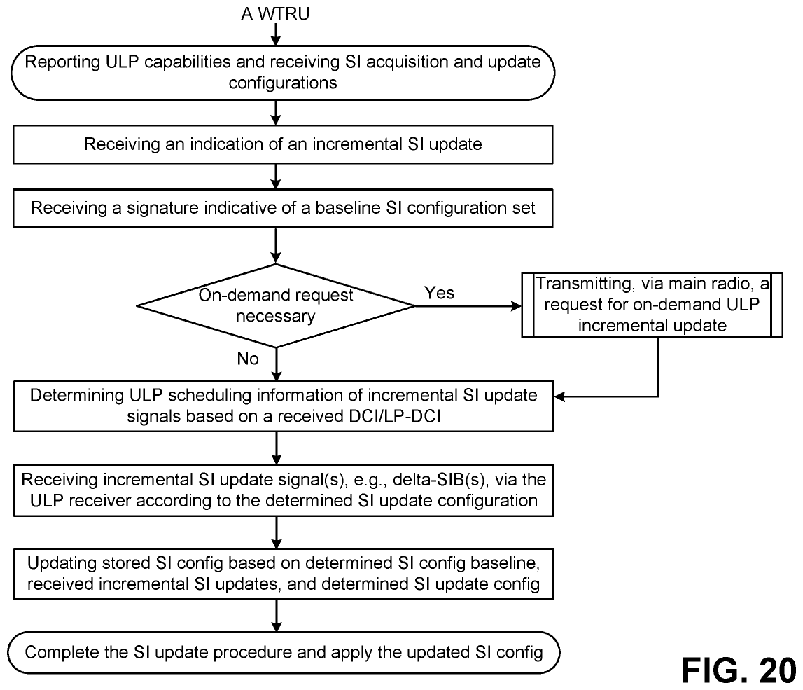

On-demand Incremental ULP SI acquisition and/or SI update may be implemented. FIG. 20 illustrates an example of a ULP receiver-capable WTRU performing incremental and on-demand ULP-based SI update(s), e.g., using the ULP receiver and/or with the help of Uu transmission request(s). The WTRU may perform one or more of the following actions. The WTRU may report ULP capability information and/or may receive SI acquisition configuration and/or SI update configuration information. The WTRU may detect (e.g., receive) an indication of an incremental and/or on-demand SI Update. The WTRU may receive a signature, which may indicate a baseline SI configuration (e.g., a selected baseline configuration, for example a selected baseline configuration from a set of baseline configurations), e.g., based on the received SI acquisition configuration. The WTRU may transmit an on-demand request, e.g., via the main/traditional radio. The WTRU may receive and/or determine scheduling information of the ULP incremental SI update signals, e.g., based on a DCI received via the main/traditional radio. The WTRU may receive the incremental SI update signals (e.g., signatures, delta-SIB(s), etc.), e.g., according to the determined scheduling configuration. The WTRU may update SI configuration parameter(s), e.g., based on the determined SI configuration baseline, the received incremental SI updates, and/or the determined SI update configuration (e.g., as described herein, for example in reference to FIGS. 7 and/or 8).

The SI acquisition configuration and/or SI update configuration may be received using system information and/or RRC signaling. The SI acquisition configuration and/or SI update configuration may be valid within a serving cell (e.g., current serving cell) and/or a set of cells in a defined area.

The SI acquisition configuration and/or SI update configuration may include one or more of a baseline SI configuration; support of incremental ULP-based and/or Tx-assisted on-demand SI update, a list of IEs and corresponding SIB(s) that are eligible for the incremental update, or an incremental update signaling format (e.g., a subset of bits in a baseline IE value to be replaced by the incremental update.

The detection of an indication of an incremental and on-demand SI update may occur, while the WTRU is operating in a ULP RRC IDLE state and/or a ULP RRC INACTIVE state.

The detection of an indication of an incremental and on-demand SI update may be determined, e.g., based on the detection of a signature indicative of the availability of an on-demand incremental SI update signaling.

The detection of an indication of an incremental and on-demand SI update may be determined, e.g., based on the detection of a signature indicative of the availability of an incremental SI update signaling and a failure to decode the ULP incremental SI update (e.g., within a certain period of time).

The transmission of the on-demand request via the main/traditional radio may be preceded by the ULP receiver device sending a wake-up signal to the main/traditional radio to transmit (e.g., via the main/traditional radio) a request for an initial or repeated transmission of an on-demand ULP incremental update.

The determination of scheduling information of the ULP incremental SI update signals may be based on the received SI update configuration and/or the determined SI configuration baseline.

The updated SI configuration may include values (e.g., new values) of cell ranking criteria offsets. The WTRU may perform cell (re-)selection evaluation, e.g., based on the updated SI configuration and may camp on a cell (e.g., a new cell).

The WTRU may send the wake-up signal to the main/traditional radio to transmit (e.g., via the main/traditional radio) a request for an on-demand ULP incremental SI update or to fall back to the traditional SI acquisition/update procedure, e.g., based on a measured received signal strength from the serving base station (BS) and/or energy determined to be used (e.g., energy required) to complete the on-demand request transmission.

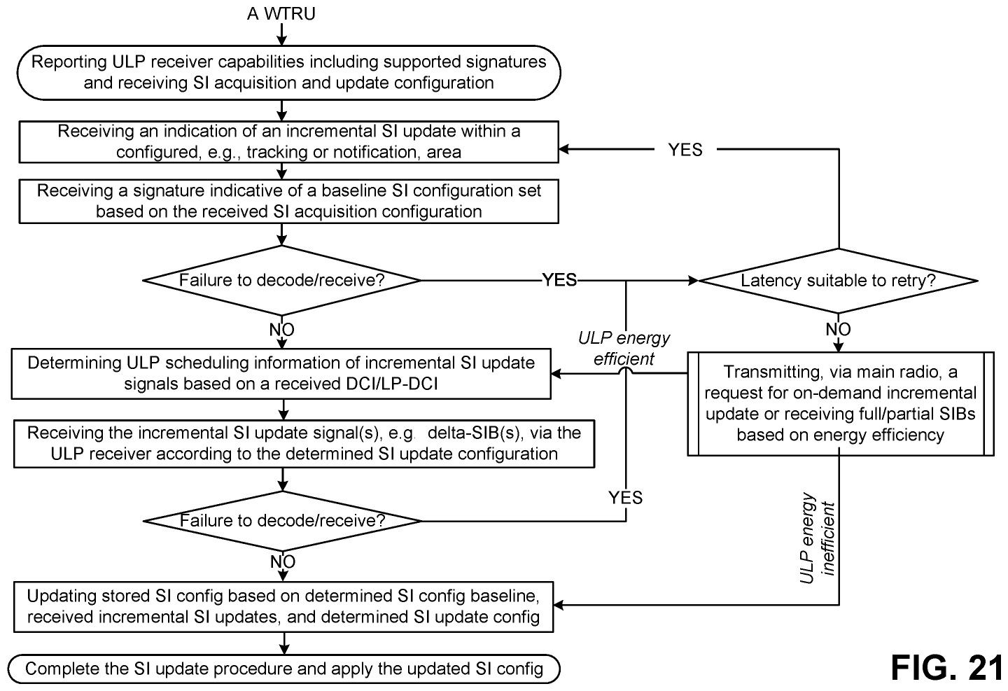

FIG. 21 illustrates an example of a ULP receiver-capable WTRU performing incremental updates and on-demand ULP-based SI update(s), e.g., using the ULP receiver and/or with the help of Uu transmission requests. The WTRU may perform one or more of the following actions. The ULP receiver may have latency and/or energy budget constraint(s). The WTRU may report ULP capability information and/or may receive SI acquisition configuration and/or SI update configuration information. The WTRU may detect an indication signature of an incremental SI signaling format. The WTRU may receive a signature, which may indicate a baseline SI configuration (e.g., a selected baseline configuration, for example a selected baseline configuration from a set of baseline configurations) based on the received SI acquisition configuration. On a first condition that a baseline signature is correctly detected and an incremental update message is missed, the WTRU may evaluate a latency tolerance. On a second condition that latency is determined intolerable, the WTRU may transmit (e.g., via the main/traditional radio) a request for an on-demand re-transmission of the ULP incremental update message. The WTRU may receive and/or determine scheduling information. The WTRU may receive an incremental SI update message (e.g., signature(s), delta-SIB(s), etc.), e.g., based on a received DCI and/or the scheduling information. The WTRU may receive the incremental SI update message via the ULP receiver. The WTRU may update SI configuration parameter(s), e.g., based on the determined SI configuration baseline, the received incremental SI updates, and/or the determined SI update configuration (e.g., as described herein, for example in reference to FIGS. 7 and/or 8).

The SI acquisition configuration and/or SI update configuration may be received, e.g., using system information and/or RRC signaling. The SI acquisition configuration and/or SI update configuration may be valid within a serving cell (e.g., current serving cell) and/or a set of cells in a defined area.

The SI acquisition configuration and/or SI update configuration may include one or more of a baseline SI configuration, support of incremental ULP-based and/or Tx-assisted on-demand SI update, a list of IEs and corresponding SIB(s) that are eligible for the incremental update, or an incremental update signaling format (e.g., a subset of bits in a baseline IE value to be replaced by the incremental update).

The detection an indication of an incremental and on-demand SI update may occur while WTRU is operating in a ULP RRC IDLE state and a ULP RRC INACTIVE state.

The latency tolerance is determined based on a configured validity time duration (e.g., a configured validity timer) and/or a ULP-based SI signaling periodicity. For example, latency is determined tolerable if an SI validity time duration (e.g., an SI validity timer) is longer than at least one period of ULP-based SI signaling. Latency is determined intolerable if an SI validity time duration (e.g., an SI validity timer) is not longer than at least one period of ULP-based SI signaling.

The latency tolerability condition may be dependent on received signal strength and/or energy budget.

The SI validity time duration (e.g., the SI validity timer) may be initialized or may be reset by the reception/detection of a signal/signature indicative of an SI configuration that corresponds to (e.g., that is identical to) the SI configuration (e.g., currently used SI configuration).

The transmission of the on-demand request via the main/traditional radio may be preceded by the ULP receiver sending a wake-up signal to the main/traditional radio to transmit a request for an initial or repeated transmission of an on-demand ULP incremental update.

The determination of scheduling information of the ULP incremental SI update signals may be based on one or more of the received SI update configuration or the determined SI configuration baseline.

The WTRU may fall back to the traditional SI acquisition/update procedure, e.g., on a condition that the WTRU fails to detect/decode a baseline SI configuration signature and/or an incremental SI update message, the WTRU determines that latency is intolerable and/or determines ULP on-demand request is below a energy efficiency threshold (e.g., inefficient from energy budget point of view).

The WTRU may decide to wait for another period of ULP SI signaling, e.g., on a condition that the WTRU fails to detect/decode a baseline SI configuration signature and/or an incremental SI update message, and the WTRU determines that latency is tolerable.

The WTRU may send the wake-up signal to the main/traditional radio to transmit (e.g., via the main/traditional radio) a request for an on-demand ULP incremental SI update or to fall back to the traditional SI acquisition/update procedure, e.g., based on a measured received signal strength from the serving BS and/or energy determined to be used (e.g., energy required) to complete the on-demand request transmission.

The baseline SI configuration may be determined, e.g., by an index in the incremental update message (e.g., instead of a dedicated signature indicating the baseline SI configuration).

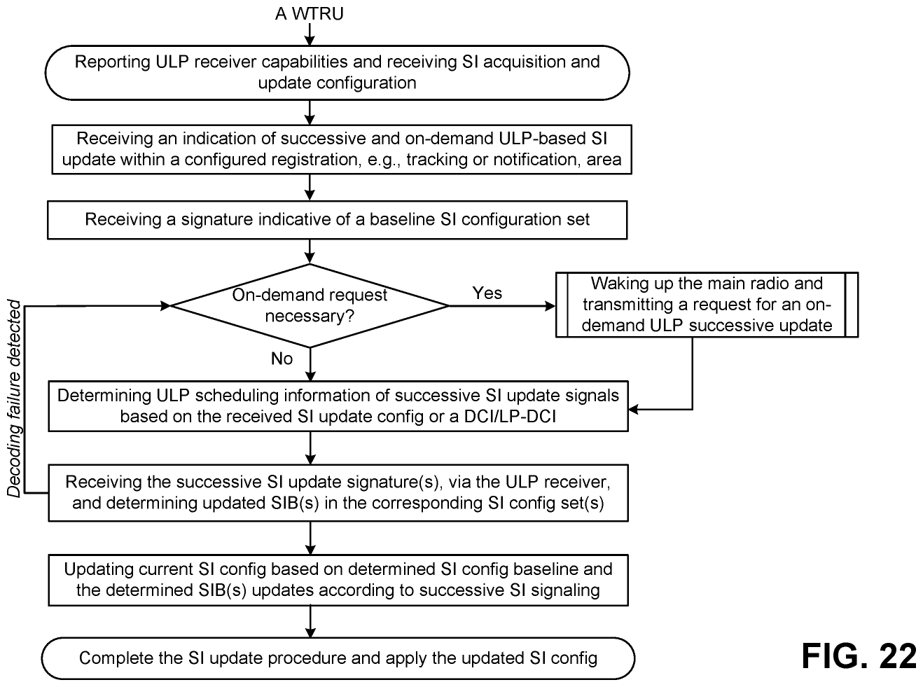

In some examples, on-demand successive ULP SI acquisition and/or SI update may be implemented. FIG. 22 illustrates a ULP receiver-capable WTRU performing successive and on-demand ULP SI update, e.g., using the ULP receiver. The WTRU may perform one or more of the following actions. The WTRU may report ULP capability information and/or may receive SI acquisition configuration and/or SI update configuration information (e.g., which may include successive update signaling format and/or SI update format). The WTRU may detect an indication of a successive and/or on-demand SI update. The WTRU may receive a signature, which may indicate a baseline SI configuration (e.g., a selected baseline configuration, for example a selected baseline configuration from a set of baseline configurations), e.g., based on the received SI acquisition configuration. The WTRU may transmit an on-demand request, e.g., via the main/traditional radio. The WTRU may receive and/or determine scheduling information of the ULP successive and/or on-demand SI update signals, e.g., based on a received DCI. The WTRU may receive (e.g., via the ULP receiver) at least, e.g., successively on at least one frequency resource, an update of a first SI configuration (e.g., according to a first detected signature) and an update of a second SI configuration (e.g., according to a second detected signature), e.g., the reception based on the determined scheduling information and/or received successive update signaling format. The WTRU may update SI configuration parameter(s), e.g., based on the determined SI configuration baseline, the received successive and/or on-demand SI updates, and/or the determined SI update format (e.g., as described herein, for example in reference to FIGS. 7 and/or 8).

The SI acquisition configuration and/or update configuration may be received, e.g., using system information and/or RRC signaling. The SI acquisition configuration and/or update configuration may be valid within a serving cell (e.g., current serving cell) and/or a set of cells in a defined area.

The SI acquisition configuration and/or update configuration may include one or more of a baseline SI configuration, support of ULP-based successive and/or Tx-assisted on-demand SI update, a list of IEs and corresponding SIB(s) that are eligible for the successive and on-demand update, and/or the scheduling/format of successive update signaling.

The successive update signaling format may include one or more of a periodicity, eligible SIBs order/number, a mapping between updates and indications or signatures, or on-demand eligibility of the update for a (e.g., each) SIB.

The detection of an indication of a successive and on-demand SI update may occur while the WTRU is operating in a ULP RRC IDLE state or a ULP RRC INACTIVE state.

The transmission of the on-demand request (e.g., via the main/traditional radio) may be preceded by the ULP receiver sending a wake-up signal to the main/traditional radio to transmit (e.g., via the main/traditional radio) a request for an initial or repeated transmission of an on-demand ULP successive update.

The determination of scheduling information of the ULP successive SI update signals may be based on the received SI update configuration and/or the determined SI configuration baseline.

The first SI configuration and/or the second SI configuration may be (e.g., at least) a sub-set of IEs of a SIB (e.g., at least one SIB).

The first detected signature and the second detected signature may be a same signature, which may be reused over one or more time and/or frequency resources.

The successive SI update configuration may include a validity time duration (e.g., a validity time) that may be used by the WTRU to determine whether to (e.g., the need to) repeat the successive update procedure, e.g., upon expiry of a time duration (e., a timer) initialized by the configured validity time duration (e.g., a validity time).

The detection of an on-demand SI update indication (e.g., a determination of a (e.g., need for) subsequent on-demand request from the WTRU) may be based on information (e.g., in a received SI update indication) indicating a determination to (e.g., the need to) update one or more SIBs in a signaled baseline SI. The update of the one or more SIBs may be transmitted (e.g., only be transmitted) on-demand.

The detection of an on-demand SI update indication (e.g., a subsequent determination of an on-demand request from the WTRU) may be based on a failure to detect one or more of the signatures (e.g., in a successive SI update signaling window), wherein the one or more of the signatures may correspond to one or more SIBs that are eligible for the on-demand request.

The WTRU may perform features described herein in a different order than described, e.g., based on triggering criteria for an on-demand SI update request. In examples, the reception of the baseline SI configuration and/or successive SI update signaling may precede the determination of (e.g., the need for) an on-demand transmission request.

In some examples, dual mode reception of SI update may be implemented.

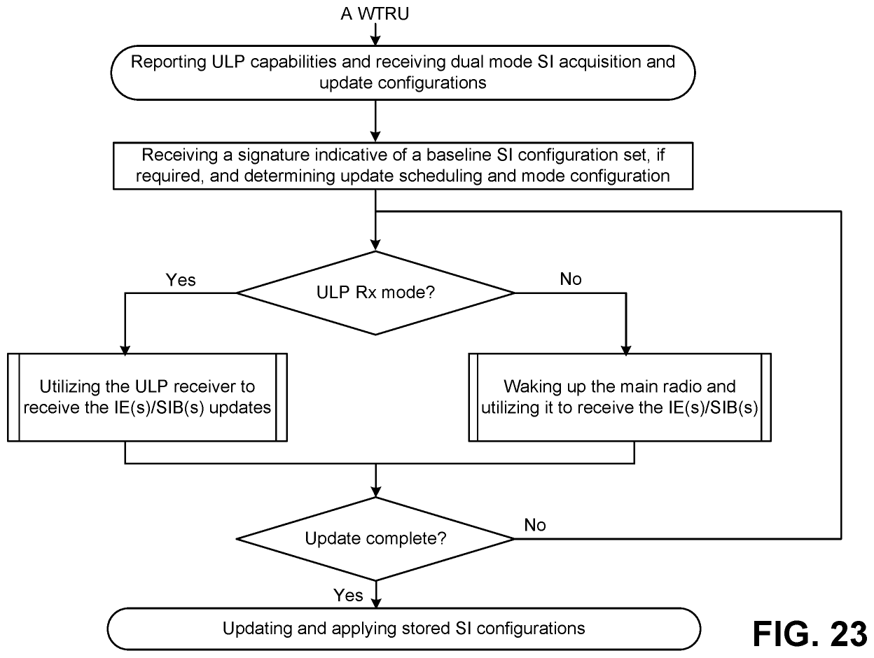

FIG. 23 illustrates an example of a ULP receiver-capable WTRU performing dual mode (ULP and main radio) reception of SI update. The WTRU may perform one or more of the following actions.

The WTRU may report ULP capability information and may receive SI acquisition configuration and/or SI update configuration information. The WTRU may receive a signature indicative of a baseline SI configuration set (e.g., a selected baseline configuration, for example a selected baseline configuration from a set of baseline configurations) and/or may receive an indication of a system information update. The WTRU may determine the ULP receiver scheduling information of a first SI configuration and/or the main radio scheduling information of a second SI configuration, e.g., based on the received indication (e.g., of the SI update) and/or reception mode scheduling configuration. The WTRU may utilize the ULP and main radio receivers (e.g., concurrently or sequentially), e.g., to receive the first and second SI configuration updates. The WTRU may updating SI configuration parameter(s), e.g., based on the determined SI configuration baseline, the received SI updates, and/or the determined SI update configuration.

The SI acquisition configuration and/or SI update configuration may be received, e.g., using system information and/or RRC signaling. The SI acquisition configuration and/or SI update configuration may be valid within a (e.g., current) serving cell and/or a set of cells in a defined area.

The SI acquisition configuration and/or SI update configuration may include an indication of the support of a dual mode (e.g., use of ULP receiver and/or the main receiver) update and/or a list of SIB(s) eligible for update in a mode (e.g., each mode), e.g., a ULP Rx mode or regular Rx mode.

The detection of an indication of an SI acquisition and/or update may occur while the WTRU is operating in a ULP RRC IDLE state or a ULP RRC INACTIVE state.

The first SI configuration and/or the second SI configuration may be (e.g., at least) a sub-set of IEs of a SIB (e.g., at least one SIB).

The first SI configuration and/or the second SI configuration may be received, e.g., using one or more of successive, incremental, or complete update signaling format.

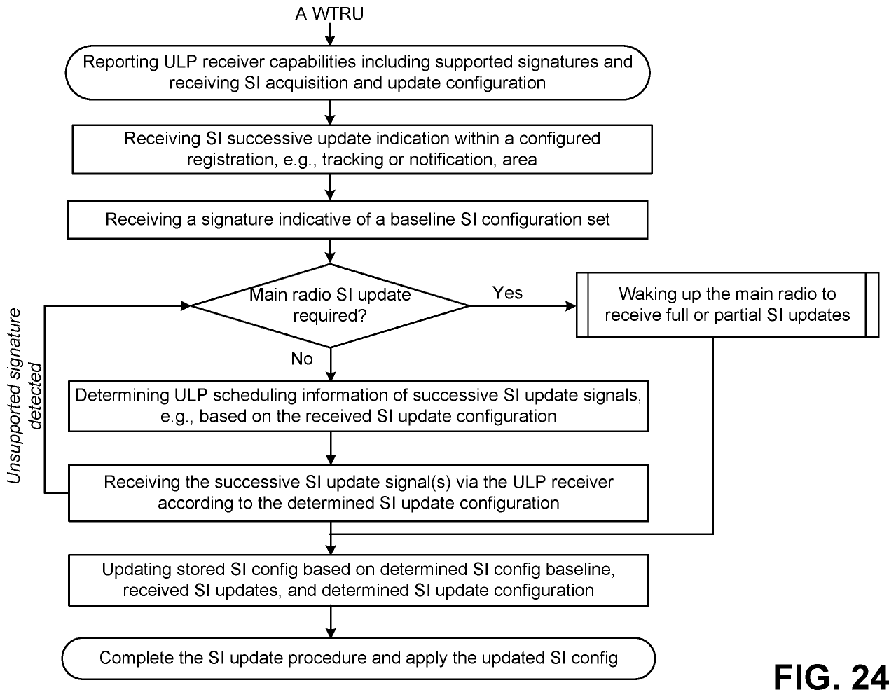

Handling of unsupported signature(s) may be implemented. FIG. 24 illustrates a ULP receiver-capable WTRU performing incremental/successive SI update using a limited set of signatures in the case of receiving an unsupported signature. The WTRU may perform one or more of the following actions.

The WTRU may report ULP capability information and/or may receive SI acquisition configuration and/or SI update configuration information (e.g., which may include SI successive update signaling format). The WTRU may receive an SI update indication, e.g., within a configured registration, such as a tracking or notification area. The WTRU may receive a signature indicative of a baseline SI configuration set (e.g., a selected baseline configuration, for example a selected baseline configuration from a set of baseline configurations), e.g., based on the received SI acquisition configuration. The WTRU may determine ULP scheduling information of successive SI update signals, e.g., based on the received SI update indication and/or configuration information. The WTRU may receive the successive SI update signals, e.g., according to the determined scheduling information and/or received SI successive update signaling format. On a condition that an unsupported signature is detected, the WTRU may utilize the main radio to receive full or partial SIB(s) updates, e.g., based on the detected successive ULP-based SI updates and correspondence between unsupported signature(s) and updated SIB(s). The WTRU may update an SI configuration (e.g., the current SI configuration), for example, based on determined SI config baseline and the determined SIB(s) updates received in ULP and/or regular reception mode(s).

The SI acquisition configuration and/or SI update configuration may be received, e.g., using system information and/or RRC signaling. The SI acquisition configuration and/or SI update configuration may be valid within a serving cell (e.g., current serving cell) and/or a set of cells in a defined area.

The SI acquisition configuration and/or SI update configuration information may include one or more of a baseline SI configuration, support of ULP-based successive or incremental SI update, a list of IEs and corresponding SIB(s) that are eligible for the successive and/or incremental update, or successive and/or incremental update signaling format.

The detection of an indication of a successive and/or an incremental SI update may occur while the WTRU is operating in a ULP RRC IDLE state or a ULP RRC INACTIVE state.

The ULP scheduling information may include one or more of a configured time offset, a time window, a time slot, a number of slots, or frequency resources, wherein the configured time offset may be with respect to a received SI update indication and/or a received signature indicative of a baseline SI configuration set.

The main radio reception (e.g., of full or partial SIB(s) updates) and/or request transmission may be preceded by the ULP receiver sending a wake-up signal to the main/traditional radio.

The main radio reception of full or partial SIB(s) updates may be preceded by the transmission of a request to receive the updates, wherein the transmission may be via the main radio and may be based on the received SI acquisition and update configuration.

The waking up of the main radio may be to request SI update signaling (e.g., explicit SI update signaling) addressed to the ULP receiver.

The usage of the main radio receiver from the WTRU may be based on the detection of an unsupported signature and/or detected failure of the signature(s), e.g., in the reception of ULP signatures for incremental or successive SI updates.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well. For example, while the system has been described with reference to a 3GPP, 5G, and/or NR network layer, the envisioned embodiments extend beyond implementations using a particular network layer technology. Likewise, the potential implementations extend to all types of service layer architectures, systems, and embodiments. The techniques described herein may be applied independently and/or used in combination with other resource configuration techniques.

The processes described herein may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read-only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

It is understood that the entities performing the processes described herein may be logical entities that may be implemented in the form of software (e.g., computer-executable instructions) stored in a memory of, and executing on a processor of, a mobile device, network node or computer system. That is, the processes may be implemented in the form of software (e.g., computer-executable instructions) stored in a memory of a mobile device and/or network node, such as the node or computer system, which computer-executable instructions, when executed by a processor of the node, perform the processes discussed. It is also understood that any transmitting and receiving processes illustrated in figures may be performed by communication circuitry of the node under control of the processor of the node and the computer-executable instructions (e.g., software) that it executes.

The various techniques described herein may be implemented in connection with hardware or software or, where appropriate, with a combination of both. Thus, the implementations and apparatus of the subject matter described herein, or certain aspects or portions thereof, may take the form of program code (e.g., instructions) embodied in tangible media including any other machine-readable storage medium wherein, when the program code is loaded into and executed by a machine, such as a computer, the machine becomes an apparatus for practicing the subject matter described herein. In the case where program code is stored on media, it may be the case that the program code in question is stored on one or more media that collectively perform the actions in question, which is to say that the one or more media taken together contain code to perform the actions, but that—in the case where there is more than one single medium—there is no requirement that any particular part of the code be stored on any particular medium. In the case of program code execution on programmable devices, the computing device generally includes a processor, a storage medium readable by the processor (including volatile and non-volatile memory and/or storage elements), at least one input device, and at least one output device. One or more programs that may implement or utilize the processes described in connection with the subject matter described herein, e.g., through the use of an API, reusable controls, or the like. Such programs are preferably implemented in a high level procedural or object-oriented programming language to communicate with a computer system. However, the program(s) can be implemented in assembly or machine language, if desired. In any case, the language may be a compiled or interpreted language and combined with hardware implementations.

Although example embodiments may refer to utilizing aspects of the subject matter described herein in the context of one or more stand-alone computing systems, the subject matter described herein is not so limited, but rather may be implemented in connection with any computing environment, such as a network or distributed computing environment. Still further, aspects of the subject matter described herein may be implemented in or across a plurality of processing chips or devices, and storage may similarly be affected across a plurality of devices. Such devices might include personal computers, network servers, handheld devices, supercomputers, or computers integrated into other systems such as automobiles and airplanes.

In describing the preferred embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose.

1-15. (canceled)

16. A wireless transmit/receive unit (WTRU), the WTRU comprising:
a main receiver;
a low power receiver; and
a processor configured to:
receive, via the main receiver, an indication of a set of baseline configurations, wherein the set of baseline configurations comprises a first baseline configuration and a second baseline configuration;
transition to a low power mode in which the main receiver is in an inactive state;
receive, via the low power receiver, an indication of the first baseline configuration;
configure at least one of the main receiver or the low power receiver based on the first baseline configuration;
receive, via the low power receiver, first update information that indicates a first change to a first information element of the first baseline configuration;
update the first baseline configuration in accordance with the first update information; and
configure at least one of the main receiver or the low power receiver based on the first updated first baseline configuration.

17. The WTRU of claim 16, wherein the processor is further configured to:
receive, via the low power receiver, second update information that indicates a second change to a second information element of the first updated first baseline configuration;
update the first updated first baseline configuration in accordance with the second update information; and
configure at least one of the main receiver or the low power receiver based on the second updated first baseline configuration.

18. The WTRU of claim 16, wherein the processor is further configured to:
receive, via the low power receiver, an indication of the second baseline configuration; and
configure at least one of the main receiver or the low power receiver based on the second baseline configuration.

19. The WTRU of claim 18, wherein the processor is further configured to:
receive, via the low power receiver, second update information that indicates a change to an information element of the second baseline configuration;
update the second baseline configuration in accordance with the second update information; and
configure at least one of the main receiver or the low power receiver based on the updated second baseline configuration.

20. The WTRU of claim 16, wherein the processor is further configured to:
determine that second update information was not received;
determine that a latency associated with the first updated first baseline configuration is above a threshold;
in response to the latency being above the threshold, send a wake-up signal to the main receiver; and
send, via the main receiver, a request for retransmission of the second update information.

21. The WTRU of claim 16, wherein the processor is further configured to:
determine that a latency associated with the first updated first baseline configuration is above a threshold;
in response to the latency being above the threshold, send a wake-up signal to the main receiver; and
send, via the main receiver, a request for second update information.

22. The WTRU of claim 16, wherein the first update information indicates for the WTRU to change a value of the first information element of the first baseline configuration to a value of an information element of the second baseline configuration.

23. The WTRU of claim 16, wherein the processor is further configured to:
receive an indication of a validity timer and a system information signaling periodicity;
on a condition that the system information signaling periodicity is longer than an amount of time remaining before the validity timer expires, determine that a latency associated with the first updated first baseline configuration is above a threshold; and
in response to the latency being above the threshold, send a wake-up signal to the main receiver.

24. A method, to be performed by a wireless transmit/receive unit (WTRU) comprising a main receiver and a low power receiver, the method comprising:
receiving, via the main receiver, an indication of a set of baseline configurations, wherein the set of baseline configurations comprises a first baseline configuration and a second baseline configuration;
transitioning to a low power mode in which the main receiver is in an inactive state;
receiving, via the low power receiver, an indication of the first baseline configuration;
configuring at least one of the main receiver or the low power receiver based on the first baseline configuration;
receiving, via the low power receiver, first update information that indicates a first change to a first information element of the first baseline configuration;
updating the first baseline configuration in accordance with the first update information; and
configuring at least one of the main receiver or the low power receiver based on the first updated first baseline configuration.

25. The method of claim 24, wherein the method further comprises:
receiving, via the low power receiver, second update information that indicates a second change to a second information element of the first updated first baseline configuration;
updating the first updated first baseline configuration in accordance with the second update information; and
configuring at least one of the main receiver or the low power receiver based on the second updated first baseline configuration.

26. The method of claim 24, wherein the method further comprises:
receiving, via the low power receiver, an indication of the second baseline configuration; and
configuring at least one of the main receiver or the low power receiver based on the second baseline configuration.

27. The method of claim 26, wherein the method further comprises:
receiving, via the low power receiver, second update information that indicates a change to an information element of the second baseline configuration;
updating the second baseline configuration in accordance with the second update information; and
configuring at least one of the main receiver or the low power receiver based on the updated second baseline configuration.

28. The method of claim 24, wherein the method further comprises:
determining that second update information was not received;
determining that a latency associated with the first updated first baseline configuration is above a threshold;
in response to the latency being above the threshold, sending a wake-up signal to the main receiver; and
sending, via the main receiver, a request for retransmission of the second update information.

29. The method of claim 24, wherein the method further comprises:
determining that a latency associated with the first updated first baseline configuration is above a threshold;
in response to the latency being above the threshold, sending a wake-up signal to the main receiver; and
sending, via the main receiver, a request for second update information.

30. The method of claim 24, wherein the first update information indicates for the WTRU to change a value of the first information element of the first baseline configuration to a value of an information element of the second baseline configuration.

31. The method of claim 24, wherein the method further comprises:
receiving an indication of a validity timer and a system information signaling periodicity;
on a condition that the system information signaling periodicity is longer than an amount of time remaining before the validity timer expires, determining that a latency associated with the first updated first baseline configuration is above a threshold; and
in response to the latency being above the threshold, sending a wake-up signal to the main receiver.

32. A wireless transmit/receive unit (WTRU), the WTRU comprising:
a main receiver;
a low power receiver; and
a processor configured to:
receive, via the main receiver, an indication of a first baseline configuration and a second baseline configuration;
receive, via the low power receiver, an indication of the first baseline configuration;
configure at least one of the main receiver or the low power receiver based on the first baseline configuration;
receive, via the low power receiver, update information that indicates a change to an information element of the first baseline configuration; and
configure at least one of the main receiver or the low power receiver based on the first baseline configuration and the update information.
